(19) United States
(12) Patent Application Publication
(10) Pub. No.: US 2026/0030125 A1
(43) Pub. Date: Jan. 29, 2026

(54) METHODS TO MAINTAIN READ-WRITE CONSISTENCY AND DEPENDENT WRITE ORDER CONSISTENCY WITHIN A CROSS-SITE STORAGE SYSTEM

(71) Applicant: NetApp, Inc., San Jose, CA (US)

(72) Inventors: Anoop Vijayan, Bangalore (IN); Akhil Kaushik, San Jose, CA (US)

(73) Assignee: NetApp, Inc., San Jose, CA (US)

(21) Appl. No.: 18/785,783

(22) Filed: Jul. 26, 2024

(51) Int. Cl. G06F 11/20; G06F 16/11; G06F 16/18

(52) U.S. Cl. CPC G06F 11/2076; G06F 16/128; G06F 16/1815

(57) ABSTRACT

The present storage solution provides an order of operations of a computer-implemented method for performing transient failure handling with an improved application I/O resumption time for a symmetric distributed storage system; an order of operations of a computer-implemented method for performing persistent failure handling with an improved application I/O resumption time for a symmetric distributed storage system; an order of operations of a computer-implemented method for performing transient failure handling with an improved application I/O resumption time to maintain dependent write order consistency for a symmetric distributed storage system; an order of operations of a computer-implemented method for performing secondary side write Op handling to maintain dependent write order consistency for a symmetric distributed storage system; and an order of operations of a computer-implemented method for performing secondary side read Op handling to maintain dependent write order consistency for a symmetric distributed storage system in accordance with some embodiments.

### FIELD

Various embodiments of the present disclosure generally relate to dual copy multi-site distributed data storage systems. In particular, some embodiments relate to methods to maintain read-write consistency and dependent write order consistency on the dual copy multi-site distributed data storage systems with simultaneous read-write ability on each copy of the data.

### BACKGROUND

Multiple storage nodes organized as a cluster may provide a distributed storage architecture configured to service storage requests issued by one or more clients of the cluster. The storage requests are directed to data stored on storage devices coupled to one or more of the storage nodes of the cluster. A fully symmetric storage solution allows simultaneous read-write access to both a primary copy and a secondary copy of the data. However, the fully symmetric storage solution presents challenges in maintaining Read-Write Consistency and Dependent Write Order Consistency across the copies, both when a replication relationship is in sync and when the replication relationship is out of sync.

### SUMMARY

Systems and methods provide a distributed storage solution to maintain Read-Write Consistency and Dependent Write Order Consistency across a primary copy of data of a primary storage site and a secondary copy of data of a secondary storage site, both when a replication relationship is in sync and when it is out of sync between the primary and secondary storage sites. The systems and methods maintain read and write consistency while allowing read-write access to both primary and secondary copies of data.

In one example, a method maintains read write consistency between a primary copy of data of a primary storage site and a secondary copy of data of a secondary storage site of a distributed storage system. The computer-implemented method comprises establishing bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO); receiving, with the primary storage site, a first write operation (Op) from a client device; writing the first write Op to a primary copy of data at the primary storage site and logging the first write Op in an op log journal; dropping the write first Op due to a network failure, which causes a replication relationship to be out of sync, when attempting to replicate the first write Op to the secondary storage site; determining a heartbeat failure when a time period for receiving a heartbeat message from the primary storage site expires; aborting a replication engine and activating a fence on the storage node of the secondary storage site to disallow read/write access in response to the heartbeat failure; and generating and sending a reconciliation request from the secondary storage site to the primary storage site due to the network failure for a resynchronization of the replication relationship between the one or more members of the first storage node and one or more members of the second storage node.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating an environment in which various embodiments may be implemented.

FIG. 2 is a block diagram illustrating an environment having potential failures within a multi-site distributed storage system in which various embodiments may be implemented.

FIG. 3 is a block diagram of a multi-site distributed storage system according to various embodiments of the present disclosure.

FIG. 4 is a block diagram illustrating a storage node in accordance with an embodiment of the present disclosure.

FIG. 5 is a block diagram illustrating the concept of a consistency group (CG) in accordance with an embodiment of the present disclosure.

FIG. 6A is a CG state diagram in accordance with an embodiment of the present disclosure.

FIG. 6B is a volume state diagram in accordance with an embodiment of the present disclosure.

FIG. 7 is a flow diagram illustrating an order of operations of a computer-implemented method for performing transient failure handling with an improved application I/O resumption time for a symmetric distributed storage system in accordance with an embodiment of the present disclosure.

FIG. 8 is a flow diagram illustrating an order of operations of a computer-implemented method for performing persistent failure handling with an improved application I/O resumption time for a symmetric distributed storage system in accordance with an embodiment of the present disclosure.

FIG. 9 is a flow diagram illustrating an order of operations of a computer-implemented method for performing transient failure handling with an improved application I/O resumption time to maintain dependent write order consistency for a symmetric distributed storage system in accordance with an embodiment of the present disclosure.

FIGS. 10A-10B illustrate a flow diagram for an order of operations of a computer-implemented method for performing secondary side write Op handling to maintain dependent write order consistency for a symmetric distributed storage system in accordance with an embodiment of the present disclosure.

FIGS. 11A-11B illustrate a flow diagram for an order of operations of a computer-implemented method for performing secondary side read Op handling to maintain dependent write order consistency for a symmetric distributed storage system in accordance with an embodiment of the present disclosure.

FIG. 12 illustrates an example computer system in which or with which embodiments of the present disclosure may be utilized.

FIG. 13 is a block diagram illustrating a cloud environment in which various embodiments may be implemented (e.g., virtual storage nodes of a primary storage site, a secondary storage site, and a tertiary storage site).

### DETAILED DESCRIPTION

Systems and methods are described for a fully symmetric storage solution that allows simultaneous read-write access to both a primary copy and a secondary copy of data. The fully symmetric storage solution provides application-granular zero recovery point objective (ZRPO) data protection that prevents any data loss and zero recovery time objective (ZRTO) transparent failover that provides instant recovery in the event of various potential faults for a primary storage site, a secondary storage site, and communication links between the primary and secondary storage sites. Concurrent read/write access to both copies in a symmetric Active/Active storage system is facilitated by bi-directional synchronous replication. This means that any write operation (WRITE op) initiated on a primary copy of a primary storage site is synchronously replicated to the secondary copy on a secondary storage site before a client receives an acknowledgment (ACK). Similarly, a WRITE op initiated on secondary copy is synchronously replicated to the primary copy before the client receives an ACK. This bi-directional sync replication ensures that both copies are always up-to-date and consistent with each other.

Despite the advantages of bi-directional synchronous replication in a symmetric Active/Active system, it presents challenges in maintaining Read-Write Consistency and Dependent Write Order Consistency across the copies, both when the replication relationship is in sync and when it is out of sync.

In one example, the primary storage site and secondary storage site are located in relatively close proximity (e.g., less than 100 km, proximity based on round trip time guarantees for synchronous replication datasets) and a tertiary storage site is located at a greater distance. In another example, one or more of the storage sites (e.g., one storage site, two storage sites, three storage sites) can be located in a private or public cloud, accessible (e.g., via a web portal) to an administrator associated with a managed service provider and/or administrators of one or more customers of the managed service provider, includes a cloud-based, monitoring system provided that network connectivity is suitable for synchronous replication between the two synchronous replicated copies. Furthermore, other combinations for the storage sites are possible, for example, one storage site on premise and two storage sites in the cloud and other such variants. The three site topology is applicable to cloud-resident workloads and datasets as well. For a fully cloud resident dataset, two sites can be in the same region (e.g., same availability zone (AZ) or different AZs with sync replication being a limit to a distance between the two sites) and the third site can be in a different region (e.g., a long distance dataset copy) or even an on premise data center. Availability zones (AZs) are isolated data centers located within specific regions in which public cloud services originate and operate. Cloud computing businesses typically have multiple worldwide availability zones. A cloud-resident workload is an application, service, capability, or a specified amount of work that consumes cloud-based resources (e.g., computing or memory power). Databases, containers, microservices, VMs, and Hadoop nodes are examples of cloud workloads.

In one embodiment, cross-site high availability is a valuable addition to cross-site zero recover point objective (RPO) that provides non-disruptive operations even if an entire local data center becomes non-functional based on a seamless failing over of storage access to a mirror copy hosted in a remote data center. This type of failover is also known as zero RTO, near zero RTO, or automatic failover. A cross-site high availability storage when deployed with host clustering enables workloads to be in both data centers.

Given that more workloads are moving to a cloud environment and many customers deploy hybrid cloud, applications will also demand these same features in the cloud including cross-site high availability, planned failover, planned migration, etc.

As such, embodiments described herein seek to improve the technological processes of multi-site distributed data storage systems. Various embodiments of the present technology provide for a wide range of technical effects, advantages, and/or improvements to multi-site distributed storage systems and components. The present storage solution provides: an order of operations of a computer-implemented method for performing transient failure handling with an improved application I/O resumption time for a symmetric distributed storage system in accordance with an embodiment of the present disclosure; an order of operations of a computer-implemented method for performing persistent failure handling with an improved application I/O resumption time for a symmetric distributed storage system in accordance with an embodiment of the present disclosure; an order of operations of a computer-implemented method for performing transient failure handling with an improved application I/O resumption time to maintain dependent write order consistency for a symmetric distributed storage system in accordance with an embodiment of the present disclosure; an order of operations of a computer-implemented method for performing secondary side write Op handling to maintain dependent write order consistency for a symmetric distributed storage system in accordance with an embodiment of the present disclosure; and an order of operations of a computer-implemented method for performing secondary side read Op handling to maintain dependent write order consistency for a symmetric distributed storage system in accordance with an embodiment of the present disclosure.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

### Example Operating Environment

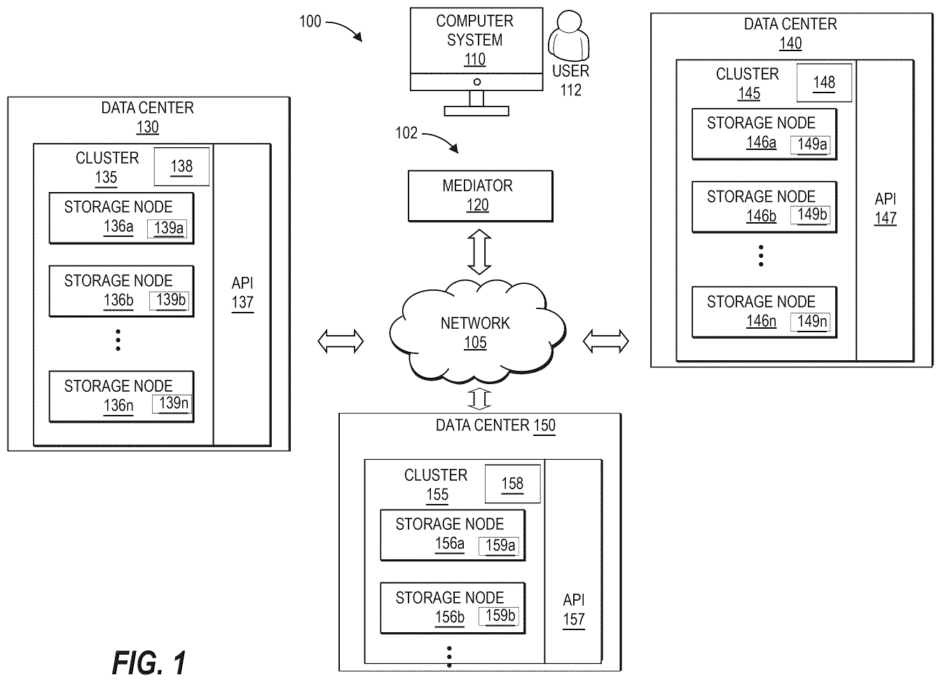

FIG. 1 is a block diagram illustrating an environment 100 in which various embodiments may be implemented. In various examples described herein, an administrator (e.g., user 112) of a multi-site distributed storage system 102 having clusters 135, 145, and optional cluster 155 or a managed service provider responsible for multiple distributed storage systems of the same or multiple customers may monitor various operations and network conditions of the distributed storage system or multiple distributed storage systems via a browser-based interface presented on computer system 110. The distributed storage system 102 provides a fully symmetric storage solution that allows simultaneous read-write access to both the primary and secondary copies of the data.

In the context of the present example, the multi-site distributed storage system 102 includes a data center 130, a data center 140, an optional data center 150, and optionally a mediator 120. The data centers 130, 140, 150, the mediator 120, and the computer system 110 are coupled in communication via a network 105, which, depending upon the particular implementation, may be a Local Area Network (LAN), a Wide Area Network (WAN), or the Internet.

The data centers 130, 140, and 150 may represent an enterprise data center (e.g., an on-premises customer data center) that is owned and operated by a company or the data center 130 may be managed by a third party (or a managed service provider) on behalf of the company, which may lease the equipment and infrastructure. Alternatively, the data centers 130, 140, and 150 may represent a colocation data center in which a company rents space of a facility owned by others and located off the company premises. The data centers are shown with a cluster (e.g., cluster 135, cluster 145, cluster 155). Those of ordinary skill in the art will appreciate additional IT infrastructure may be included within the data centers 130, 140, and 150. In one example, the data center 140 is a mirrored copy of the data center 130 to provide non-disruptive operations at all times even in the presence of failures including, but not limited to, network disconnection between the data centers 130 and 140 and the mediator 120, which can also be located at a data center. The cluster 155 of optional data center 150 can have an asynchronous relationship, synchronous relationship, or be a vault retention of the cluster 135 of the data center 130.

Turning now to the cluster 135, it includes a configuration database 138, multiple storage nodes 136a-n each having a respective mediator agent 139a-n, and an Application Programming Interface (API) 137. In the context of the present example, the multiple storage nodes 136a-n are organized as a cluster and provide a distributed storage architecture to service storage requests issued by one or more clients (not shown) of the cluster. The configuration database may store configuration information for a cluster. A configuration database provides cluster wide storage for storage nodes within a cluster. The data served by the storage nodes 136a-n may be distributed across multiple storage units embodied as persistent storage devices, including but not limited to HDDs, SSDs, flash memory systems, or other storage devices. In a similar manner, cluster 145 includes a configuration database 148, multiple storage nodes 146a-n each having a respective mediator agent 149a-n, and an Application Programming Interface (API) 147. In the context of the present example, the multiple storage nodes 146a-n are organized as a cluster and provide a distributed storage architecture to service storage requests issued by one or more clients of the cluster. Turning now to the optional cluster 155, it includes a configuration database 158, multiple storage nodes 156a-b each having a respective mediator agent 159a-b, and an Application Programming Interface (API) 157.

The API 137 may provide an interface through which the cluster 135 is configured and/or queried by external actors (e.g., computer system 110, data center 140, the mediator 120, clients). Depending upon the particular implementation, the API 137 may represent a Representational State Transfer (REST) ful API that uses Hypertext Transfer Protocol (HTTP) methods (e.g., GET, POST, PATCH, DELETE, and OPTIONS) to indicate its actions. Depending upon the particular embodiment, the API 137 may provide access to various telemetry data (e.g., performance, configuration, storage efficiency metrics, and other system data) relating to the cluster 135 or components thereof. As those skilled in the art will appreciate various other types of telemetry data may be made available via the API 137, including, but not limited to measures of latency, utilization, and/or performance at various levels (e.g., the cluster level, the storage node level, or the storage node component level).

In the context of the present example, the mediator 120, which may represent a private or public cloud accessible (e.g., via a web portal) to an administrator associated with a managed service provider and/or administrators of one or more customers of the managed service provider, includes a cloud-based, monitoring system.

While for sake of brevity, only three data centers are shown in the context of the present example, it is to be appreciated that additional clusters owned by or leased by the same or different companies (data storage subscribers/customers) may be monitored and one or more metrics may be estimated based on data stored within a given level of a data store in accordance with the methodologies described herein and such clusters may reside in multiple data centers of different types (e.g., enterprise data centers, managed services data centers, or colocation data centers).

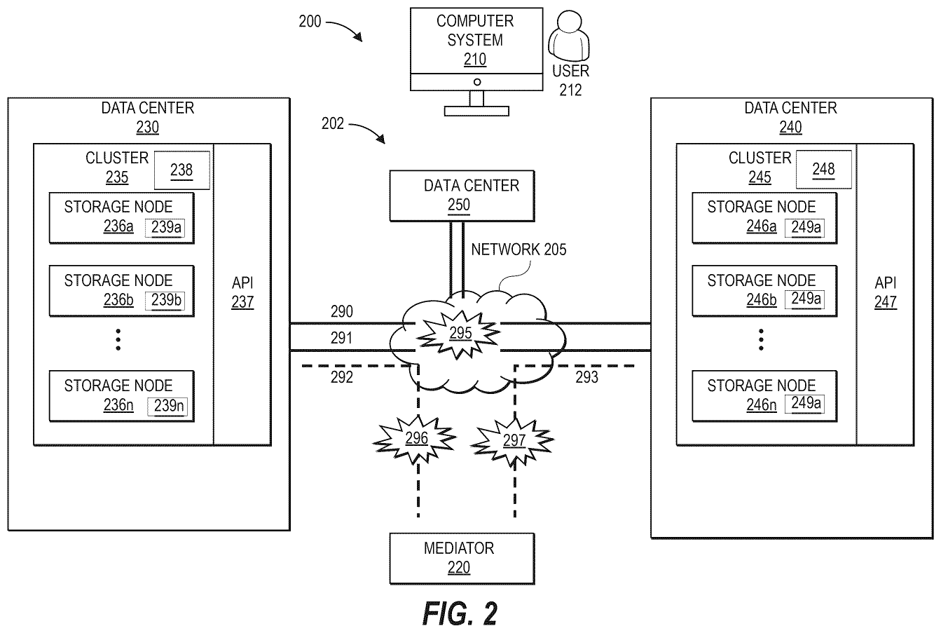

FIG. 2 is a block diagram illustrating an environment 200 having potential failures within a multi-site distributed storage system 202 in which various embodiments may be implemented. In various examples described herein, an administrator (e.g., user 212) of a multi-site distributed storage system 202 having clusters 235 and cluster 245 or a managed service provider responsible for multiple distributed storage systems of the same or multiple customers may monitor various operations and network conditions of the distributed storage system or multiple distributed storage systems via a browser-based interface presented on computer system 210.

In the context of the present example, the system 202 includes data center 230, data center 240, an optional data center 250, and optionally a mediator 220. The data centers 230, 240, and 250, the mediator 220, and the computer system 210 are coupled in communication via a network 205, which, depending upon the particular implementation, may be a Local Area Network (LAN), a Wide Area Network (WAN), or the Internet.

The data centers 230, 240, and 250 may represent an enterprise data center (e.g., an on-premises customer data center) that is owned and operated by a company or the data center 230 may be managed by a third party (or a managed service provider) on behalf of the company, which may lease the equipment and infrastructure. Alternatively, the data centers 230, 240 and 250 may represent a colocation data center in which a company rents space of a facility owned by others and located off the company premises. The data centers 230 and 240 are shown with a cluster (e.g., cluster 235, cluster 245). The data center 250 includes similar components as data centers 230 and 240. Those of ordinary skill in the art will appreciate additional IT infrastructure may be included within the data centers 230 and 240. In one example, the data center 240 is a mirrored copy of the data center 230 to provide non-disruptive operations at all times even in the presence of failures including, but not limited to, network disconnection between the data centers 230 and 240 and the mediator 220, which can also be a data center.

The system 202 can utilize communications 290 and 291 to synchronize a mirrored copy of data of the data center 240 with a primary copy of the data of the data center 230. Either of the communications 290 and 291 between the data centers 230 and 240 may have a failure 295. In a similar manner, a communication 292 between data center 230 and mediator 220 may have a failure 296 while a communication 293 between the data center 240 and the mediator 220 may have a failure 297. If not responded to appropriately, these failures whether transient or permanent have the potential to disrupt operations for users of the distributed storage system 202. In one example, communications between the data centers 230 and 240 have approximately a 5-20 millisecond round trip time.

Turning now to the cluster 235, it includes a configuration database 238, at least two storage nodes 236a-b, optionally includes additional storage nodes (e.g., 236n) and an Application Programming Interface (API) 237. The storage nodes 236a-n each include a respective mediator agent 239a-n. In the context of the present example, the multiple storage nodes are organized as a cluster and provide a distributed storage architecture to service storage requests issued by one or more clients of the cluster. The data served by the storage nodes may be distributed across multiple storage units embodied as persistent storage devices, including but not limited to HDDs, SSDs, flash memory systems, or other storage devices.

Turning now to the cluster 245, it includes a configuration database 248, at least two storage nodes 246a-b, optionally includes additional storage nodes (e.g., 246n) and includes an Application Programming Interface (API) 247. The storage nodes 246a-n each include a respective mediator agent 249a-n. In the context of the present example, the multiple storage nodes are organized as a cluster and provide a distributed storage architecture to service storage requests issued by one or more clients of the cluster. The data served by the storage nodes may be distributed across multiple storage units embodied as persistent storage devices, including but not limited to HDDs, SSDs, flash memory systems, or other storage devices.

A synchronous replication from a primary copy of data at a primary storage site (e.g., cluster 235) to a secondary copy of data at a secondary storage site (e.g., cluster 245) can fail due to inter cluster or cluster to mediator connectivity issues (e.g., failures 295, 296, 297). These issues can occur if the secondary storage site can not differentiate between the primary storage site being non-operational (or isolation), or just a network partition. A trigger for the automated failover is generated from a data path and if the data path is lost, this can lead to disruption. A data replication relationship between the primary and secondary storage sites guarantees non-disruptiveness due to allowing I/O operations to be handled with the secondary mirror copy of data. However, there are timing windows between the primary storage site being non-operational and the secondary mirror copy being ready to serve I/O operations where a second failure can lead to disruption. For example, a controller failure can occur in a cluster hosting the secondary mirror copy of the data. The failover feature of the present design guarantees non-disruptive operations (e.g., operations of business enterprise applications, operations of software application) even in the presence of these multiple failures.

In one example, each cluster can have up to 5 consistency groups with each consistency group having up to 12 volumes. The system 202 provides an automatic unplanned failover feature at a consistency group granularity. The failover feature allows switching storage access from a primary copy of the data center 230 to a mirror copy of the data center 240 or vice versa.

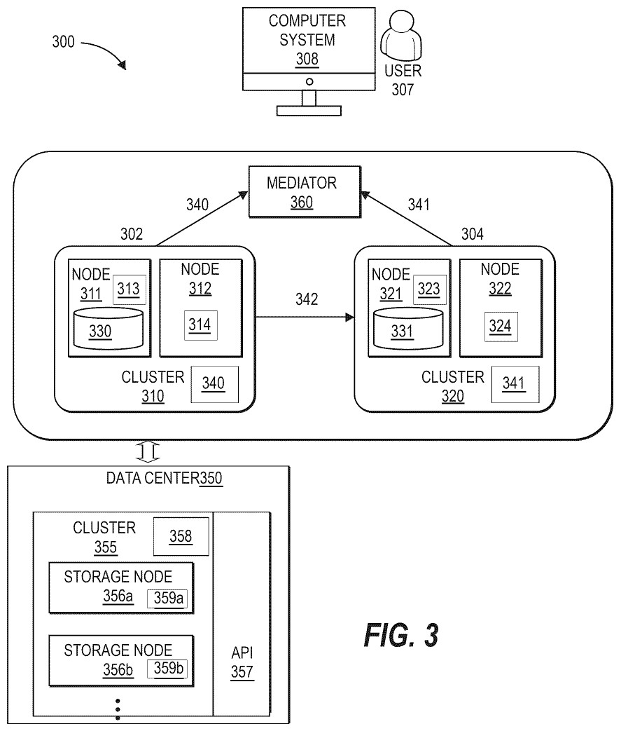

FIG. 3 is a block diagram illustrating a multi-site distributed storage system 300 in which various embodiments may be implemented. In various examples described herein, an administrator (e.g., user 307) of the multi-site distributed storage system 300 or a managed service provider responsible for multiple distributed storage systems of the same or multiple customers may monitor various operations and network conditions of the distributed storage system or multiple distributed storage systems via a browser-based interface presented on computer system 308. In the context of the present example, the distributed storage system 300 includes a data center 302 having a cluster 310, a data center 304 having a cluster 320, an optional data center 350 having a cluster 355, and a mediator 360. The clusters 310, 320, 355, and the mediator 360 are coupled in communication (e.g., communications 340-342) via a network, which, depending upon the particular implementation, may be a Local Area Network (LAN), a Wide Area Network (WAN), or the Internet.

The cluster 310 includes nodes 311 and 312, the cluster 320 includes nodes 321 and 322, and the optional cluster 355 includes nodes 356a and 356b. In one example, the cluster 320 has a data copy 331 that is a mirrored copy of the data copy 330 to provide non-disruptive operations at all times even in the presence of multiple failures including, but not limited to, network disconnection between the data centers 302 and 304 and the mediator 360. The cluster 355 may have an asynchronous replication relationship with cluster 310 or a mirror vault policy. The cluster 355 includes a configuration database 358, multiple storage nodes 356a-b each having a respective mediator agent 359a-b, and an Application Programming Interface (API) 357.

The multi-site distributed storage system 300 provides correctness of data, availability, and redundancy of data. In one example, the node 311 is designated as a leader and the node 321 is designated as a follower. The leader is given preference to serve I/O operations to requesting clients and this allows the leader to obtain a consensus in a case of a race between the clusters 310 and 320. The mediator 360 enables an automated unplanned failover (AUFO) in the event of a failure. The data copy 330 (leader), data copy 331 (follower), and the mediator 360 form a three way quorum. If two of the three entities reach an agreement for whether the leader or follower should serve I/O operations to requesting clients, then this forms a strong consensus.

The leader and follower roles for the clusters 310 and 320 help to avoid a split-brain situation with both of the clusters simultaneously attempting to serve I/O operations. For example, the leader may become unresponsive while a mediator detects this unresponsiveness to be a leader non-operational situation. The leader being non-operational can potentially cause a race between leader and follower copy both simultaneously attempting to obtain a consensus. However, only one of the leader and the follower should win the race and then be allowed to handle I/O operations. If this race is not prevented, it can result in the split-brain situation.

There are scenarios where both leader and follower copies can claim to be a leader copy. In one example, a follower cannot serve I/O until an AUFO happens. A leader doesn't serve I/O operations until the leader obtains a consensus.

The mediator agents (e.g., 313, 314, 323, 324, 359a, 359b) are configured on each node within a cluster. The system 300 can perform appropriate actions based on event processing of the mediator agents. The mediator agent(s) processes events that are generated at a lower level (e.g., volume level, node level) and generates an output for a consistency group level. In one example, the nodes 311, 312, 321, and 322 form a consistency group. The mediator agent provides services for various events (e.g., simultaneous events, conflicting events) generated in a business data replication relationship between each cluster.

The multi-site distributed storage system 300 presents a single virtual logical unit number (LUN) to a host computer or client using a synchronized-replicated distributed copies of a LUN. A LUN is a unique identifier for designating an individual or collection of physical or virtual storage devices that execute input/output (I/O) commands with a host computer, as defined by the Small System Computer Interface (SCSI) standard. In one example, active or passive access to this virtual LUN causes read and write commands to be serviced only by node 311 (leader) while operations received by the node 321 (follower) are proxied to node 311.

### Example Storage Node

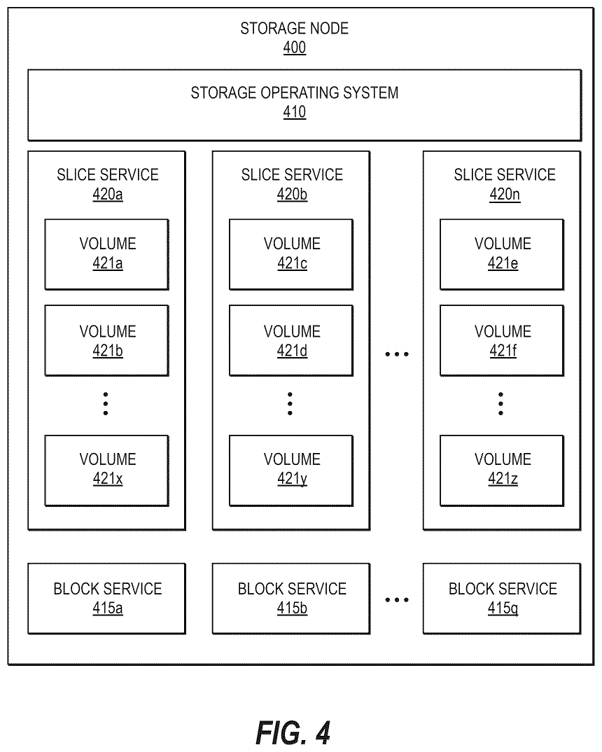

FIG. 4 is a block diagram illustrating a storage node 400 in accordance with an embodiment of the present disclosure. Storage node 400 represents a non-limiting example of storage nodes (e.g., 136a-n, 146a-n, 236a-n, 246a-n, 311, 312, 331, 322, 712, 714, 752, 754) described herein. In the context of the present example, a storage node 400 may be a network storage controller or controller that provides access to data stored on one or more volumes. The storage node 400 includes a storage operating system 410, one or more slice services 420a-n, and one or more block services 415a-q. The storage operating system (OS) 410 may provide access to data stored by the storage node 400 via various protocols (e.g., small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. A non-limiting example of the storage OS 410 is NetApp Element Software (e.g., the SolidFire Element OS) based on Linux and designed for SSDs and scale-out architecture with the ability to expand up to 100 storage nodes.

Each slice service 420 may include one or more volumes (e.g., volumes 421a-x, volumes 421c-y, and volumes 421e-z). Client systems (not shown) associated with an enterprise may store data to one or more volumes, retrieve data from one or more volumes, and/or modify data stored on one or more volumes.

The slice services 420a-n and/or the client system may break data into data blocks. Block services 415a-q and slice services 420a-n may maintain mappings between an address of the client system and the eventual physical location of the data block in respective storage media of the storage node 400. In one embodiment, volumes 421 include unique and uniformly random identifiers to facilitate even distribution of a volume's data throughout a cluster (e.g., cluster 135). The slice services 420a-n may store metadata that maps between client systems and block services 415. For example, slice services 420 may map between the client addressing used by the client systems (e.g., file names, object names, block numbers, etc. such as Logical Block Addresses (LBAs)) and block layer addressing (e.g., block IDs) used in block services 415. Further, block services 415 may map between the block layer addressing (e.g., block identifiers) and the physical location of the data block on one or more storage devices. The blocks may be organized within bins maintained by the block services 415 for storage on physical storage devices (e.g., SSDs).

As noted above, a bin may be derived from the block ID for storage of a corresponding data block by extracting a predefined number of bits from the block identifiers. In some embodiments, the bin may be divided into buckets or “sublists” by extending the predefined number of bits extracted from the block identifier. A bin identifier may be used to identify a bin within the system. The bin identifier may also be used to identify a particular block service 415a-q and associated storage device (e.g., SSD). A sublist identifier may identify a sublist with the bin, which may be used to facilitate network transfer (or syncing) of data among block services in the event of a failure or crash of the storage node 400. Accordingly, a client can access data using a client address, which is eventually translated into the corresponding unique identifiers that reference the client's data at the storage node 400.

For each volume 421 hosted by a slice service 420, a list of block IDs may be stored with one block ID for each logical block on the volume. Each volume may be replicated between one or more slice services 420 and/or storage nodes 400, and the slice services for each volume may be synchronized between each of the slice services hosting that volume. Accordingly, failover protection may be provided in case a slice service 420 fails, such that access to each volume may continue during the failure condition.

### Consistency Groups

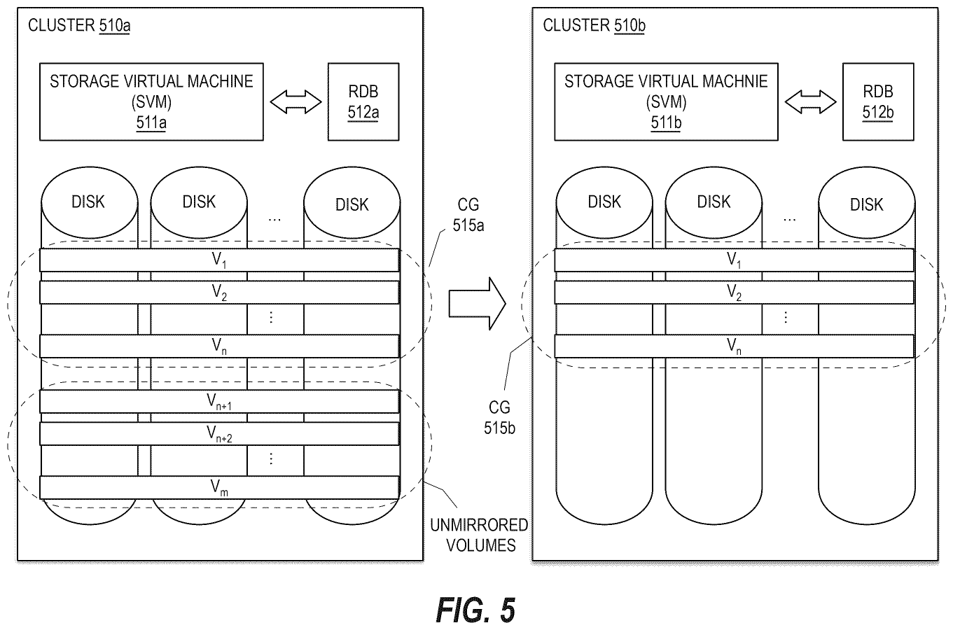

FIG. 5 is a block diagram illustrating the concept of a consistency group (CG) in accordance with an embodiment of the present disclosure. In the context of the present example, a stretch cluster including two clusters (e.g., cluster 510a and 510b) is shown. The clusters may be part of a cross-site high-availability (HA) solution that supports zero recovery point objective (RPO) and zero recovery time objective (RTO) protections by, among other things, providing a mirror copy of a dataset at a remote location, which is typically in a different fault domain than the location at which the dataset is hosted. For example, cluster 510a may be operable within a first site (e.g., a local data center) and cluster 510b may be operable within a second site (e.g., a remote data center) so as to provide non-disruptive operations even if, for example, an entire data center becomes non-functional, by seamlessly failing over the storage access to the mirror copy hosted in the other data center.

According to some embodiments, various operations (e.g., data replication, data migration, data protection, failover, storage expansion, container expansion, conversion process, and the like) may be performed at the level of granularity of a CG (e.g., CG 515a or CG 515b). A CG is a collection of storage objects or data containers (e.g., volumes) within a cluster that are managed by a Storage Virtual Machine (e.g., SVM 511a or SVM 511b) as a single unit. In various embodiments, the use of a CG as a unit of data replication guarantees a dependent write-order consistent view of the dataset and the mirror copy to support zero RPO and zero RTO. CGs may also be configured for use in connection with taking simultaneous snapshot images of multiple volumes, for example, to provide crash-consistent copies of a dataset associated with the volumes at a particular point in time.

The volumes of a CG may span multiple disks (e.g., electromechanical disks and/or SSDs, redundant array of independent (RAID) disks) of one or more storage nodes of the cluster. RAID disks store the same data in different place on multiple hard disks or SSDs to protect data in case of a drive failure. A CG may include a subset or all volumes of one or more storage nodes. In one example, a CG includes a subset of volumes of a first storage node and a subset of volumes of a second storage node. In another example, a CG includes a subset of volumes of a first storage node, a subset of volumes of a second storage node, and a subset of volumes of a third storage node. A CG may be referred to as a local CG or a remote CG depending upon the perspective of a particular cluster. For example, CG 515a may be referred to as a local CG from the perspective of cluster 510a and as a remote CG from the perspective of cluster 510b. Similarly, CG 515a may be referred to as a remote CG from the perspective of cluster 510b and as a local CG from the perspective of cluster 510b. At times, the volumes of a CG may be collectively referred to herein as members of the CG and may be individually referred to as a member of the CG. In one embodiment, members may be added or removed from a CG after it has been created.

A cluster may include one or more SVMs, each of which may contain data volumes and one or more logical interfaces (LIFs) (not shown) through which they serve data to clients. SVMs may be used to securely isolate the shared virtualized data storage of the storage nodes in the cluster, for example, to create isolated partitions within the cluster. In one embodiment, an LIF includes an Internet Protocol (IP) address and its associated characteristics. Each SVM may have a separate administrator authentication domain and can be managed independently via a management LIF to allow, among other things, definition and configuration of the associated CGs.

In the context of the present example, the SVMs make use of a configuration database (e.g., replicated database (RDB) 512a and 512b), which may store configuration information for their respective clusters. A configuration database provides cluster wide storage for storage nodes within a cluster. The configuration information may include relationship information specifying the status, direction of data replication, relationships, and/or roles of individual CGs, a set of CGs, members of the CGs, and/or the mediator. A pair of CGs may be said to be “peered” when one is protecting the other. For example, a CG (e.g., CG 515b) to which data is configured to be synchronously replicated may be referred to as being in the role of a destination CG, whereas the CG (e.g., CG 515a) being protected by the destination CG may be referred to as the source CG. Various events (e.g., transient or persistent network connectivity issues, availability/unavailability of the mediator, site failure, and the like) impacting the stretch cluster may result in the relationship information being updated at the cluster and/or the CG level to reflect changed status, relationships, and/or roles.

The level of granularity of operations supported by a CG is useful for various types of applications. As a non-limiting example, consider an application, such as a database application, that makes use of multiple volumes, including maintaining logs on one volume and the database on another volume. In such a case, the application may be assigned to a local CG of a first cluster that maintains the primary dataset, including an appropriate number of member volumes to meet the needs of the application, and a remote CG, for maintaining a mirror copy of the primary dataset, may be established on a second cluster to protect the local CG.

While in the context of various embodiments described herein, a volume of a CG may be described as performing certain actions (e.g., taking other members of a CG out of synchronization, disallowing/allowing access to the dataset or the mirror copy, issuing consensus protocol requests, etc.), it is to be understood such references are shorthand for an SVM or other controlling entity, managing or containing the volume at issue, performing such actions on behalf of the volume.

While in the context of various examples described herein, data replication may be described as being performed in a synchronous manner between a paired set of (or “peered”) CGs associated with different clusters (e.g., from a primary cluster to a secondary cluster), data replication may also be performed asynchronously and/or within the same cluster. Similarly, a single remote CG may protect multiple local CGs and/or multiple remote CGs may protect a single local CG. For example, a local CG can be setup for double protection by two remote CGs via fan-out or cascade topologies. In addition, those skilled in the art will appreciate a cross-site high-availability (HA) solution may include more than two clusters, in which a mirrored copy of a dataset of a primary cluster is stored on more than one secondary cluster.

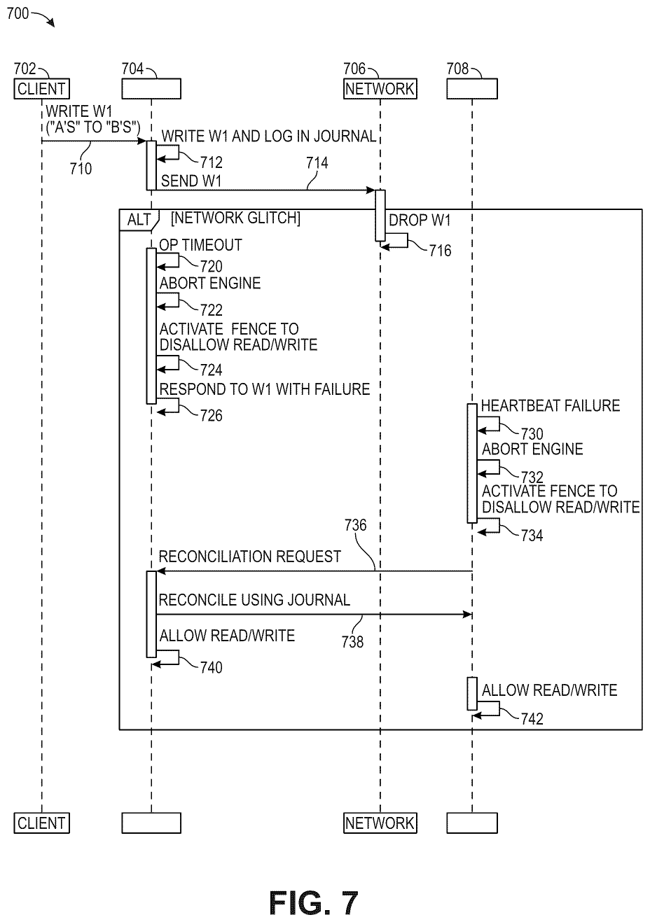

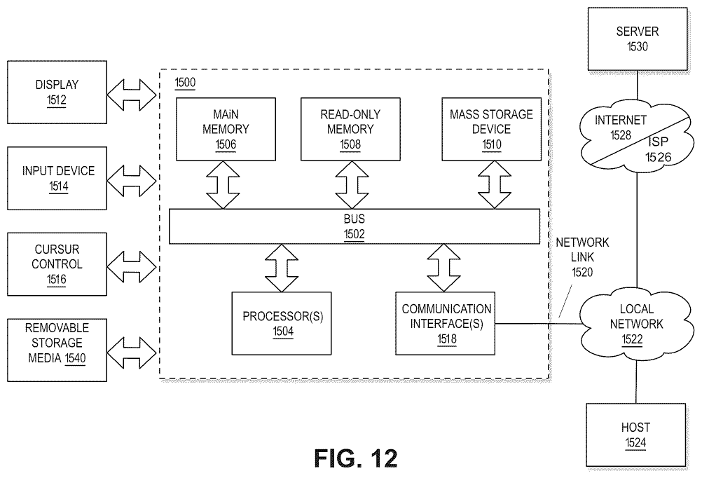

The various nodes (e.g., storage nodes) of the distributed storage systems described herein, and the processing described below with reference to the flow diagrams of FIGS. 7-11B may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems (e.g., servers, network storage systems or appliances, blades, etc.) of various forms, such as the computer system described with reference to FIG. 12 below.

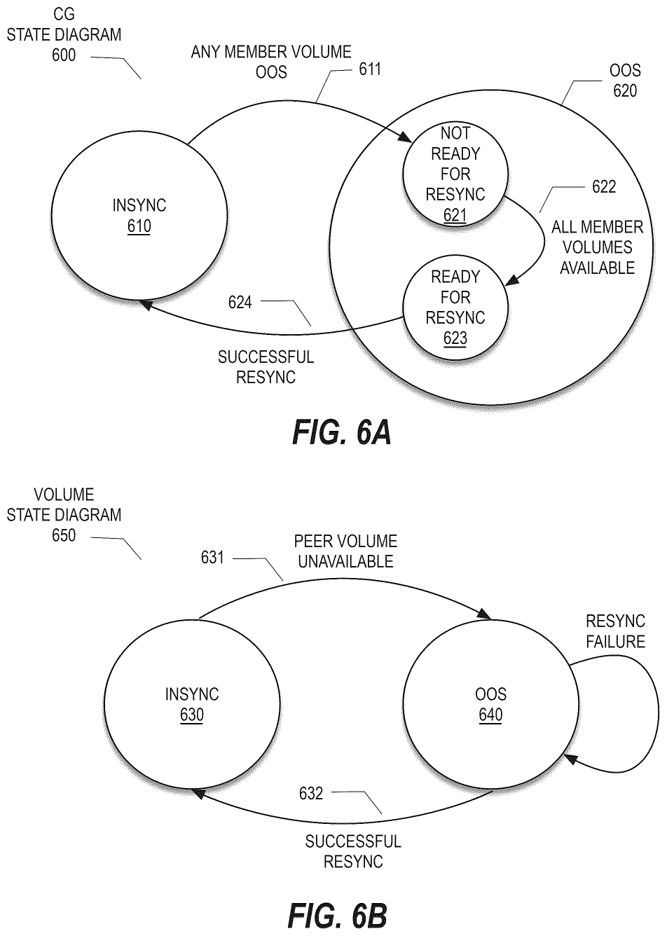

FIG. 6A is a CG state diagram 600 in accordance with an embodiment of the present disclosure. In the context of the present example, the data replication status of a CG can generally be in either of an InSync state (e.g., InSync 610) or an OOS state (e.g., OOS 620). Within the OOS state, two sub-states are shown, a not ready for resync state 621 and a ready for resync state 623.

While a given CG is in the InSync state, the mirror copy of the primary dataset associated with the member volumes of the given CG may be said to be in-synchronization with the primary dataset and asynchronous data replication or synchronous data replication, as the case may be, are operating as expected. When a given CG is in the OOS state, the mirror copy of the primary dataset associated with the member volumes of the given CG may be said to be out-of-synchronization with the primary dataset and asynchronous data replication or synchronous data replication, as the case may be, are unable to operate as expected. Information regarding the current state of the data replication status of a CG may be maintained in a configuration database (e.g., RDB 512a or 512b).

As noted above, in various embodiments described herein, the members (e.g., volumes) of a CG may be managed as a single unit for various situations. In the context of the present example, the data replication status of a given CG is dependent upon the data replication status of the individual member volumes of the CG. A given CG may transition 611 from the InSync state to the not ready for resync state 621 of the OOS state responsive to any member volume of the CG becoming OOS with respect to a peer volume with which the member volume is peered. A given CG may transition 622 from the not ready for resync state 621 to the ready for resync state 623 responsive to all member volumes being available. In order to support recovery from, among other potential disruptive events, manual planned disruptive events (e.g., balancing of CG members across a cluster) a resynchronization process is provided to bring the CG back into the InSync state from the OOS state. Responsive to a successful CG resync, a given CG may transition 624 from the ready for resync state 623 to the InSync state.

Although outside the scope of the present disclosure, for completeness it is noted that additional state transitions may exist. For example, in some embodiments, a given CG may transition from the ready for resync state 623 to the not ready for resync state 621 responsive to unavailability of a mediator (e.g., mediator 120) configured for the given CG. In such an embodiment, the transition 622 from the not ready for resync state 621 to the ready for resync state 623 should additionally be based on the communication status of the mediator being available.

FIG. 6B is a volume state diagram 650 in accordance with an embodiment of the present disclosure. In the context of the present example, the data replication status of a volume can be in either of an InSync state (e.g., InSync 630) or an OOS state (e.g., OOS 640). While a given volume of a local CG (e.g., CG 515a) is in the InSync state, the given volume may be said to be in-synchronization with a peer volume of a remote CG (e.g., CG 515b) and the given volume and the peer volume are able to communicate with each other via the potentially unreliable network (e.g., network 205), for example, through their respective LIFs. When a given volume of the local CG is in the OOS state, the given volume may be said to be out-of-synchronization with the peer volume of the remote CG and the given volume and the peer volume are unable to communicate with each other. According to one embodiment, a periodic health check task may continuously monitor the ability to communicate between a pair of peered volumes. Information regarding the current state of the data replication status of a volume may be maintained in a configuration database (e.g., RDB 512a or 512b).

A given volume may transition 631 from the InSync state to the OOS state responsive to a peer volume being unavailable. A given volume may transition 632 from the OOS state to the InSync state responsive to a successful resynchronization with the peer volume. As described below in further detail, in one embodiment, two different types of resynchronization approaches may be implemented, including a Fast Resync process and a CG-level resync process, and selected for use individually or in sequence as appropriate for the circumstances.

### Read-Write Consistency

The present design maintains read and write consistency while allowing read-write access to both copies of a distributed storage system. However, there are potential issues related to consistency, particularly when a write operation is initiated on one side and a read operation occurs on the other side on the same region before the write gets replicated.

In a steady state, both reading and writing are allowed from both copies. However, a write operation is only acknowledged after it has been successfully processed by both the primary copy and secondary mirror copy. This could potentially lead to consistency issues if a read operation returns new data before a write operation is completed. For example, consider the following scenario:
1. An application of a client device issues a write operation (w1)
2. W1 is committed on the primary copy of a primary storage site and not yet replicated to secondary copy of the secondary storage site nor acknowledged back.
3. The application issues a read on the primary copy and deduces that w1 is written.
4. The application then issues a dependent write (w2) on the secondary copy based on the new data read.
5. If a failover operation happens at this point, the secondary copy will have w2 but not w1, leading to inconsistency.

However, a SCSI protocol doesn't provide any guarantees on the read of regions operated by inflight writes. Hence, like a standalone system, a business continuity solution for a storage area network (SAN) will not suspend reads for regions where writes are in-flight.

For a transient failure lasting a short time period, this causes transient failure handling. Consider the following scenario:

1. A write operation W1 is modifying a LUN from a series of “a's” to a series of “b's” for a primary copy.

2. This write is successfully processed by the primary storage site but is in-flight for the replication to the secondary copy of the secondary storage site.

3. At this point, the contents of the LUN will be “b's” on the primary copy and “a's” on the secondary copy.

4. A network glitch occurs at this point and replication of W1 fails to the secondary copy.

5. Reads from the primary copy will return “b's” and reads from the secondary mirror copy will return “a's”.

To prevent this inconsistency, in the event of a transient failure, where a write cannot be replicated to the secondary copy of the secondary storage site, reads and writes will be temporarily disallowed (e.g., fence operation) on both copies. The copies are reconciled using a persistent journalling based fast-resync workflow which replays any writes that were in-flight during the failure event and brings the filesystem of the secondary storage site up to date and the replication relationship back in sync. Read write access is restored on both primary and secondary copies at this point.

FIG. 7 is a flow diagram illustrating an order of operations of a computer-implemented method for performing transient failure handling with an improved application I/O resumption time for a symmetric distributed storage system in accordance with an embodiment of the present disclosure. State information regarding members (e.g., storage volumes) of a local CG can be maintained. The state information may include a data replication status of a mirror copy of a dataset associated with a local CG (e.g., CG 515a) may be maintained, for example, to facilitate automatic triggering of resynchronization. For example, the state information may include information relating to the current availability or unavailability of a peer volume of a remote CG corresponding to a member volume of the local CG and/or the data replication state of the local CG. In one embodiment, the state information may track the current state of a given CG and a given volume consistent with the state diagrams of FIG. 6A and FIG. 6B.

Although the operations in the computer-implemented method 700 are shown in a particular order, the order of the actions can be modified. Thus, the illustrated embodiments can be performed in a different order, and some operations may be performed in parallel. Some of the operations listed in FIG. 7 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of computer-implemented method 700 may be executed by a storage controller, a storage virtual machine (e.g., SVM 511a, SVM 511b), a mediator (e.g., mediator 120, mediator 220, mediator 360), a mediator agent (e.g., mediator agent 139a-139n, mediator agent 149a-149n, mediator agent 239a-239n, mediator agent 249a-249n, mediator agent 313, 314, 323, 324, mediator agent 439), a multi-site distributed storage system, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

In one embodiment, a multi-site distributed storage system includes the primary storage site 704 having a first cluster with a primary copy of data in a consistency group (CG1). The consistency group of the first cluster is initially assigned primary role. A second cluster of the secondary storage site 708 has a secondary mirror copy of the data in a consistency group. The consistency group of the second cluster (CG2) is initially assigned a secondary role. The storage system handles input/output (I/O) requests from the client device 702 having an application. The primary storage site 704 and secondary storage site 708 communicate via a network 706. Initially, the method establishes bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO).

At operation 710, the method includes receiving, with the primary storage site, a write operation W1 from a client device. At operation 712, the method includes writing W1 (e.g., with a's being written as b's) to primary copy of data at primary storage site 704 and logging the write W1 in an op log journal. In this example, a network connection for the network 706 is failing and the network is not able to send write W1 to the secondary storage site 708. At operation 716, the method includes dropping the write operation W1 at the network 706. At operation 720, an Op timeout expires due to no acknowledgement of the write W1 being received by the secondary storage site. This causes a replication engine to abort at operation 722 and activation of a fence on the primary storage site at operation 724 to disallow read/write operations. Then, at operation 726, the method includes responding to write W1 with a failure status meaning the write W1 was not successfully written to the secondary storage site 708.

According to one embodiment, the secondary storage site 708 periodically receives heartbeat messages from the primary storage site 704 during normal conditions with no failures. However, at operation 730, a time period for receiving a heartbeat message from the primary storage site expires and this causes a heartbeat failure. A replication engine aborts at operation 732 and activation of a fence on the secondary storage site occurs at operation 734 to disallow read/write operations in response to the heartbeat failure.

At operation 736, a reconciliation request is sent from the secondary storage site 708 to the primary storage site 704. In response to this reconciliation request, at operation 738, the reconciliation process between Op log journals in the primary storage site and the secondary storage site occurs to ensure both sites have the same operations and data. In response to the completion of the reconciliation process, at operation 740, the method includes allowing read/write operations on the primary storage site 704. At operation 744, the method includes allowing read/write operations on the secondary storage site 708.

For a persistent failure lasting a longer time period (e.g., greater than 50-80 seconds), this causes persistent failure handling. Consider the following scenario:

1. A write operation W1 is modifying a LUN from a series of “a's” to a series of “b's” for a primary copy.

2. This write is successfully processed by the primary storage site but is in-flight for the replication to the secondary copy of the secondary storage site.

3. At this point, the contents of the LUN will be “b's” on the primary copy and “a's” on the secondary copy.

4. A network partition occurs at this point and replication of W1 fails to the secondary copy.

5. Reads from the primary copy will return “b's” and reads from the secondary mirror copy will return “a's”.

To prevent this inconsistency, in the event of a persistent failure (e.g., network partition, one site/storage cluster/copy going down), reads and writes will be allowed for a surviving copy of the data while reads and writes will be temporarily disallowed (e.g., fence operation) for a copy on a secondary storage site having a failure or loss of connection to the storage site until a snapshot-based resync has completed that brings the filesystem of the secondary storage site up to date and the replication relationship back in sync. Read write access is restored on both primary and secondary copies at this point.

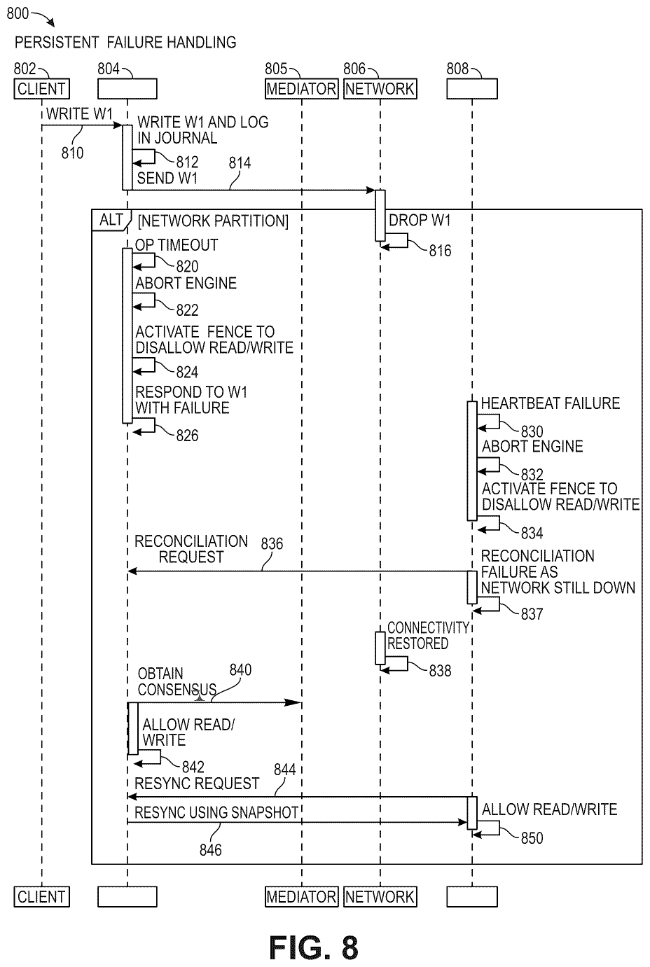

FIG. 8 is a flow diagram illustrating an order of operations of a computer-implemented method for performing persistent failure handling with an improved application I/O resumption time for a symmetric distributed storage system in accordance with an embodiment of the present disclosure. State information regarding members (e.g., storage volumes) of a local CG can be maintained. The state information may include a data replication status of a mirror copy of a dataset associated with a local CG (e.g., CG 515a) may be maintained, for example, to facilitate automatic triggering of resynchronization. For example, the state information may include information relating to the current availability or unavailability of a peer volume of a remote CG corresponding to a member volume of the local CG and/or the data replication state of the local CG. In one embodiment, the state information may track the current state of a given CG and a given volume consistent with the state diagrams of FIG. 6A and FIG. 6B.

Although the operations in the computer-implemented method 800 are shown in a particular order, the order of the actions can be modified. Thus, the illustrated embodiments can be performed in a different order, and some operations may be performed in parallel. Some of the operations listed in FIG. 8 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of computer-implemented method 800 may be executed by a storage controller, a storage virtual machine (e.g., SVM 511a, SVM 511b), a mediator (e.g., mediator 120, mediator 220, mediator 360), a mediator agent (e.g., mediator agent 139a-139n, mediator agent 149a-149n, mediator agent 239a-239n, mediator agent 249a-249n, mediator agent 313, 314, 323, 324, mediator agent 439), a multi-site distributed storage system, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

In one embodiment, a multi-site distributed storage system includes the primary storage site 804 having a first cluster with a primary copy of data in a consistency group (CG1). The consistency group of the first cluster is initially assigned primary role. A second cluster of the secondary storage site 808 has a secondary mirror copy of the data in a consistency group. The consistency group of the second cluster (CG2) is initially assigned a secondary role. The storage system handles input/output (I/O) requests from the client device 802 having an application. The primary storage site 804 and secondary storage site 808 communicate via a network 806. Initially, the method establishes bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO).

At operation 810, the method includes receiving a write operation. At operation 812, the method includes writing W1 (e.g., with a's being written as b's) to primary copy of data at primary storage site 804 and logging the write W1 in an op log journal. In this example, a network connection for the network 806 is failing and the network is not able to send write W1 to the secondary storage site 808 at operation 814. At operation 816, the method includes dropping the write operation W1 at the network 806. At operation 820, an Op timeout expires due to an acknowledgement from the secondary storage site not being received for the write W1. This causes a replication engine to abort at operation 822 and activation of a fence on the primary storage site at operation 824 to disallow read/write operations. Then, at operation 826, the method includes responding to write W1 with a failure status meaning the write W1 was not successfully written to the secondary storage site 808.

According to one embodiment, the secondary storage site 808 periodically receives heartbeat messages from the primary storage site 804 during normal conditions with no failures. However, at operation 830, a time period for receiving a heartbeat message from the primary storage site expires and this causes a heartbeat failure. A replication engine aborts at operation 832 and activation of a fence on the secondary storage site occurs at operation 834 to disallow read/write operations in response to the heartbeat failure.

At operation 836, a reconciliation request is sent from the secondary storage site 808 to the primary storage site 804. However, due to the network being non-operational, this reconciliation request fails at operation 837. At operation 838, the operation and connectivity of the network is restored. In response to the connectivity restoration, at operation 840, the method includes generating and sending a Consensus request from the primary storage site 804 to the mediator 805. At operation 842, upon the mediator and primary storage site 804 voting to grant Consensus to the primary storage site, the method includes allowing read/write operations on the primary storage site 804. Then, the secondary storage site 808 sends a resynchronization request to the primary storage site 804 at operation 844. Resynchronization between the primary and second storage sites occurs at operation 846 using one or more snapshots of the contents of storage nodes of the primary storage site. After resynchronization, the primary copy of data on the primary storage site will be the same as a secondary copy of data on the secondary storage site. Then, the method includes allowing read/write operations on the secondary storage site 808. The symmetric distributed storage system is then able to allow simultaneous read-write access to both the primary and secondary copies of the data. The storage system provides application-granular zero recovery point objective (ZRPO) data protection that prevents any data loss and zero recovery time objective (ZRTO) transparent failover that provides instant recovery in the event of various faults.

### Dependent Write Order Consistency

In one example, write operation (Op) 2 is dependent on write Op 1 (W1). Write order consistency guarantees the presence of write Op 1, upon the presence of write Op 2 (W2). The symmetric storage solution ensures that the primary and mirror copy are always dependent write order consistent, regardless of the state of replication and granularity. The dependent write order consistency is naturally maintained when replication is intact, and the system is ‘InSync’. But when the replication encounters errors like Op failure, network partition etc., the system should ensure dependent write order consistency, especially with respect to in-flight operations on both endpoints. Even in situations where the secondary mirror copy is having a data loss, it should be dependent write order consistent, and must be in a usable state upon a manual or forced failover, by virtue of its consistent state.

In a steady state, dependent write order is guaranteed by ensuring that a write is not responded to until it is successfully committed on both the primary and secondary mirror copy. This means that a dependent write will only be issued by an application of the client device after the first one is responded to. For example, consider two write Ops W1 and W2, where W2 is dependent on W1. In a steady state, these writes cannot be in-flight at the same time, ensuring dependent write order consistency.

Transient failures are handled by a fast-resync based non-disruptive operational design that disallows new reads and writes from both primary and secondary mirror copies until fast-resync completes. This prevents a dependent write from being accepted and applied to the secondary mirror copy before the write it depends on. For example, suppose a write W1 is applied on the primary storage site but fails to replicate to the secondary mirror copy due to a transient network issue. By disallowing reads and writes from the primary storage site and secondary mirror storage site, a dependent write W2 will be suspended until fast-resync completes, maintaining dependent write order consistency.

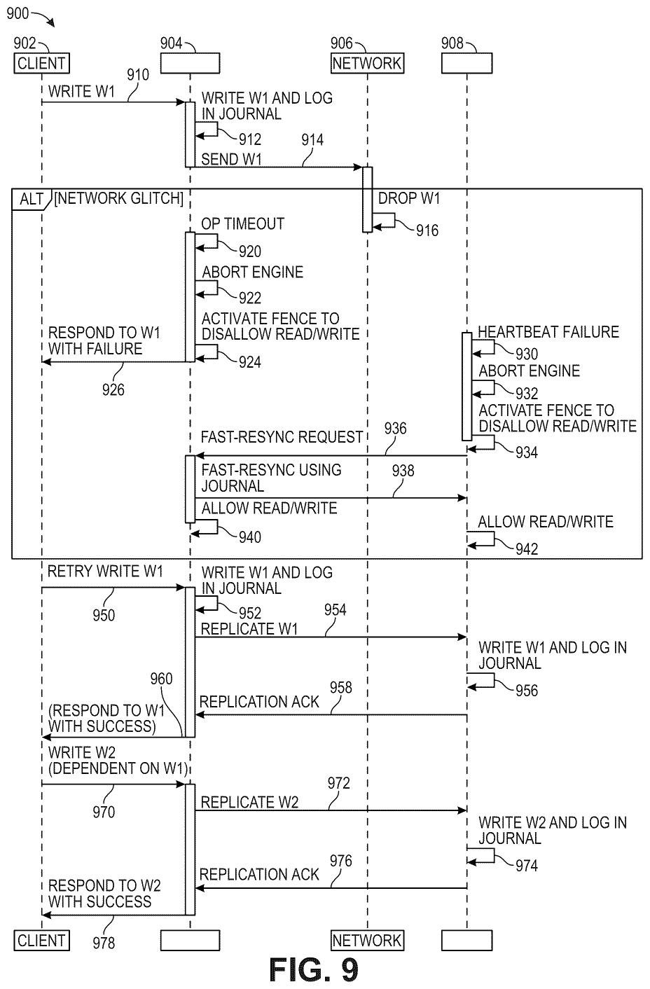

FIG. 9 is a flow diagram illustrating an order of operations of a computer-implemented method for performing transient failure handling with an improved application I/O resumption time to maintain dependent write order consistency for a symmetric distributed storage system in accordance with an embodiment of the present disclosure. State information regarding members (e.g., storage volumes) of a local CG can be maintained. The state information may include a data replication status of a mirror copy of a dataset associated with a local CG (e.g., CG 515a) may be maintained, for example, to facilitate automatic triggering of resynchronization. For example, the state information may include information relating to the current availability or unavailability of a peer volume of a remote CG corresponding to a member volume of the local CG and/or the data replication state of the local CG. In one embodiment, the state information may track the current state of a given CG and a given volume consistent with the state diagrams of FIG. 6A and FIG. 6B.

Although the operations in the computer-implemented method 900 are shown in a particular order, the order of the actions can be modified. Thus, the illustrated embodiments can be performed in a different order, and some operations may be performed in parallel. Some of the operations listed in FIG. 9 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of computer-implemented method 900 may be executed by a storage controller, a storage virtual machine (e.g., SVM 511a, SVM 511b), a mediator (e.g., mediator 120, mediator 220, mediator 360), a mediator agent (e.g., mediator agent 139a-139n, mediator agent 149a-149n, mediator agent 239a-239n, mediator agent 249a-249n, mediator agent 313, 314, 323, 324, mediator agent 439), a multi-site distributed storage system, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

In one embodiment, a multi-site distributed storage system includes the primary storage site 904 having a first cluster with a primary copy of data in a consistency group (CG1). The consistency group of the first cluster is initially assigned primary role. A second cluster of the secondary storage site 908 has a secondary mirror copy of the data in a consistency group. The consistency group of the second cluster (CG2) is initially assigned a secondary role. The storage system handles input/output (I/O) requests from the client device 902 having an application. The primary storage site 904 and secondary storage site 908 communicate via a network 906. Initially, the method establishes bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO).

At operation 910, the method includes receiving a write operation with primary storage site 904 from a client device 902. At operation 912, the method includes writing W1 to primary copy of data at primary storage site 904 and logging the write W1 in an op log journal. In this example, a network connection for the network 906 is failing and the network is not able to send write W1 to the secondary storage site 908 at operation 914. At operation 916, the method includes termination (e.g., dropping) the write operation W1 at the network 906. At operation 920, an Op timeout expires due to an acknowledgement from the secondary storage site not being received for the write W1. This causes a replication engine to abort at operation 922 and activation of a fence on the primary storage site at operation 924 to disallow read/write operations. Then, at operation 926, the method includes responding to write W1 with a failure status meaning the write W1 was not successfully written to the secondary storage site 908.

According to one embodiment, the secondary storage site 908 periodically receives heartbeat messages from the primary storage site 904 during normal conditions with no failures. However, at operation 930, a time period for receiving a heartbeat message from the primary storage site expires and this causes a heartbeat failure. A replication engine aborts at operation 932 and activation of a fence on the secondary storage site occurs at operation 934 to disallow read/write operations in response to the heartbeat failure.

At operation 936, a fast resynchronization request is sent from the secondary storage site 908 to the primary storage site 904. Due to the network being operational, this fast resynchronization request succeeds at operation 938 using op log journaling between op logs of the primary and second storage sites. At operation 940, the method includes deactivating a fence to allow read/write access on the primary storage site. At operation 942, the method includes deactivating a fence to allow read/write access on the secondary storage site.

In response to the successful resynchronization, at operation 950, the method includes retrying a write Op W1 being sent to the primary storage site 904. At operation 952, the method includes writing W1 and logging W1 in a journal on the primary storage site 904. Then, the method includes replicating W1 to the secondary storage site 908 at operation 954. At operation 956, the method includes writing W1 and logging W1 in a journal on the secondary storage site 904.

At operation 958, the method includes a replication acknowledgement being sent from the secondary storage site to the primary storage site. At operation 960, the method includes responding to the client device with a successful W1.

In response to the successful W1, at operation 970, the method includes receiving a dependent write Op W2 at the primary storage site 904 from the client device. At operation 972, the method includes replicating W2 to the secondary storage site 908 at operation 972. At operation 974, the method includes writing 21 and logging W2 in a journal on the secondary storage site 904. At operation 976, the method includes a replication acknowledgement being sent from the secondary storage site to the primary storage site. At operation 978, the method includes responding to the client device with a successful W2.

Persistent failures that disrupt zero RPO are handled using a snapshot-based resync. Dependent write order consistency of a secondary mirror copy is guaranteed via the following designs. A primary storage site of a distributed storage system implements a coordinated OOS procedure to ensure write order consistency across primary and secondary copies. This design suspends client device responses for writes that have completed on a volume affected by replication failure. A CG wide transaction is performed that aborts replication data path on all constituent volumes. The inflight ops will be responded to client devices only after ensuring that all constituents of the CG on the master side are suspended and their replication channels are torn down. This prevents replication of a dependent Op via another constituent volume which is still InSync. Further, a copy of the data for a storage site that acquires quorum consensus will resume I/O locally. The other copy will respond to I/O with a failure.

Dependent Op execution of secondary side write ops are prevented by a primary-first replication principle. In this dual-copy system, operations are performed in a sequential manner and on the primary copy first. In case of conflicts, the requests landing on a primary copy of a primary storage site are prioritized over those received by the secondary storage site. For example, a write request W1 received by a storage cluster of a primary storage site is executed on the primary storage site and then replicated to the secondary storage site. Alternatively, a write request W2 received by the secondary storage site is first replicated to the primary storage site first and then executed locally. Once a synchronous replication relation goes OOS between the primary and secondary storage sites, the primary storage site aborts a replication engine session on all constituents (e.g., volumes or members within a consistency group), hence the secondary storage site cannot replicate ops to the primary storage site and thereby cannot execute it locally as well.

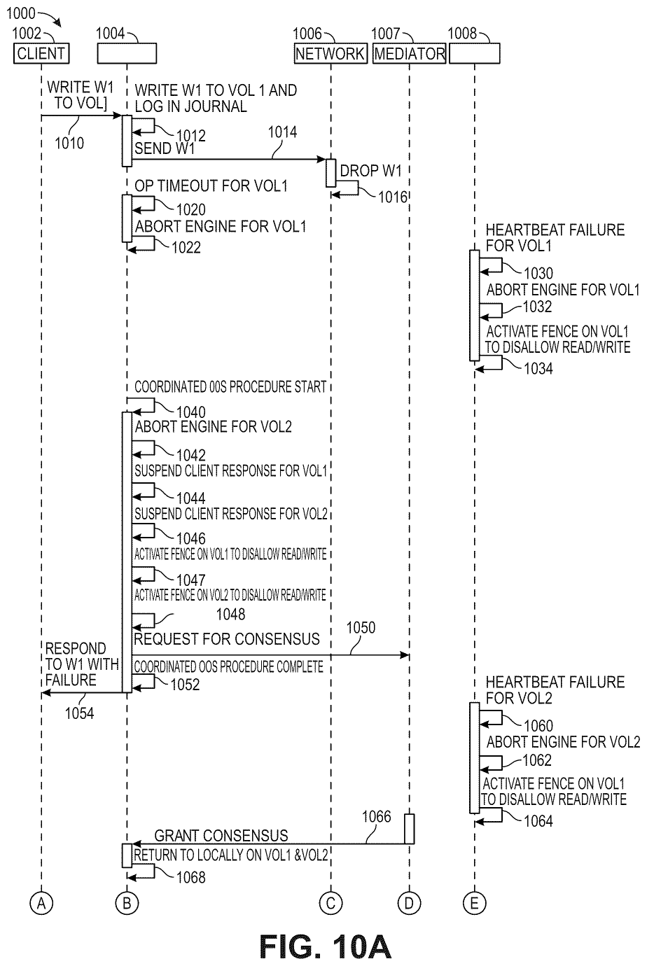

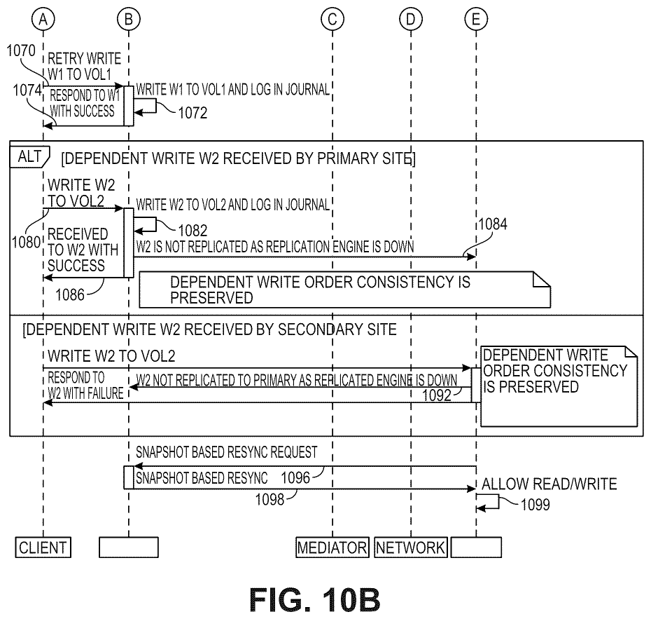

FIGS. 10A-10B illustrate a flow diagram for an order of operations of a computer-implemented method for performing secondary side write Op handling to maintain dependent write order consistency for a symmetric distributed storage system in accordance with an embodiment of the present disclosure. State information regarding members (e.g., storage volumes) of a local CG can be maintained. The state information may include a data replication status of a mirror copy of a dataset associated with a local CG (e.g., CG 515a) may be maintained, for example, to facilitate automatic triggering of resynchronization. For example, the state information may include information relating to the current availability or unavailability of a peer volume of a remote CG corresponding to a member volume of the local CG and/or the data replication state of the local CG. In one embodiment, the state information may track the current state of a given CG and a given volume consistent with the state diagrams of FIG. 6A and FIG. 6B.

Although the operations in the computer-implemented method 1000 are shown in a particular order, the order of the actions can be modified. Thus, the illustrated embodiments can be performed in a different order, and some operations may be performed in parallel. Some of the operations listed in FIGS. 10A-10B are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of computer-implemented method 1000 may be executed by a storage controller, a storage virtual machine (e.g., SVM 511a, SVM 511b), a mediator (e.g., mediator 120, mediator 220, mediator 360), a mediator agent (e.g., mediator agent 139a-139n, mediator agent 149a-149n, mediator agent 239a-239n, mediator agent 249a-249n, mediator agent 313, 314, 323, 324, mediator agent 439), a multi-site distributed storage system, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

In one embodiment, a multi-site distributed storage system includes the primary storage site 1004 having a first cluster with a primary copy of data in a consistency group (CG1). The consistency group of the first cluster is initially assigned primary role. A second cluster of the secondary storage site 1008 has a secondary mirror copy of the data in a consistency group. The consistency group of the second cluster (CG2) is initially assigned a secondary role. The storage system handles input/output (I/O) requests from the client device 1002 having an application. The primary storage site 1004 and secondary storage site 1008 communicate via a network 1006. Initially, the method establishes bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO).

At operation 1010, the method includes receiving a write operation with a first member (e.g., volume) of a primary storage site 1004 from a client device 1002. At operation 1012, the method includes writing W1 to the first member at primary storage site 1004 and logging the write W1 in an op log journal. In this example, a network connection for the network 1006 is failing and the network is not able to send write W1 to the secondary storage site 1008 at operation 1014. At operation 1016, the method includes terminating (e.g., dropping) the write operation W1 at the network 1006. At operation 1020, an Op timeout expires due to an acknowledgement not being received at the first member for the write W1. This causes a replication engine to abort at operation 1022.

According to one embodiment, the secondary storage site 1008 periodically receives heartbeat messages from the primary storage site 1004 during normal conditions with no failures. However, at operation 1030, a time period for receiving a heartbeat message from the primary storage site expires and this causes a heartbeat failure. A replication engine aborts at operation 1032 and activation of a fence on a first member (e.g., volume) of the secondary storage site occurs at operation 1034 to disallow read/write operations in response to the heartbeat failure.

At operation 1040, a coordinated OOS procedure starts due to the first member of the primary storage site being out of sync (OOS) with the first member of the secondary storage site. At operation 1042, the method includes aborting a replication engine for a second member of the primary storage site. At operation 1044, the method includes suspending a response to a client device for the first member. At operation 1046, the method includes suspending a response to the client device for the second member. At operation 1047, the method includes disallowing read/write access on the primary storage site by activating a fence on the first member. At operation 1048, the method includes disallowing read/write access on the second member of the primary storage site by activating a fence on the second member.

At operation 1050, the method includes sending a request for Consensus from the primary storage site to the mediator 1007. At operation 1052, the method includes completing the coordinated OOS procedure.

At operation 1054, the method includes responding to W1 with a failure message being sent to the client device.

At operation 1060, a time period for receiving a heartbeat message from the second member of the primary storage site expires and this causes a heartbeat failure. A replication engine for the second member aborts at operation 1062 and activation of a fence on the second member (e.g., volume) of the secondary storage site occurs at operation 1064 to disallow read/write operations on the second member in response to the heartbeat failure.

At operation 1066, the mediator 1007 grants Consensus to the primary storage site and I/O operations are resumed on the first and second members of the primary storage site at operation 1068.

In response to the Consensus being granted to the primary storage site, at operation 1070, the method includes retrying a write Op W1 being sent to the primary storage site 1004. At operation 1072, the method includes writing W1 and logging W1 in a journal on the primary storage site 1004. Then, the method includes responding to the client device with a successful W1 at operation 1074.

In response to the successful W1, at operation 1080, the method includes receiving a dependent write Op W2 at the primary storage site 1004 from the client device. At operation 1082, the method includes writing W2 to the second member and logging W2 in a journal of the primary storage site 1004. At operation 1084, the method includes no replicating of W2 to the secondary storage site due to the replication engine being non-operational. A dependent write order consistency at the secondary storage site is maintained due to no executing of W2 on the secondary storage site. At operation 1086, the method includes responding to the client device with a successful W2.

At operation 1090, the method includes receiving a dependent write Op W2 at the secondary storage site 1008 from the client device. At operation 1092, the method includes no replicating of W2 to the primary storage site due to the replication engine being non-operational. A dependent write order consistency at the secondary storage site is maintained due to no executing of W2 on the secondary storage site. At operation 1094, the method includes responding to the client device with a failure of W2.

At operation 1096, the method includes sending a snapshot based resynchronization request from the secondary storage node to the primary storage node. At operation 1098, the method includes performing the snapshot based resynchronization for the first and second members of the primary and secondary storage sites. At operation 1099, the method includes allowing read/write access on the first and second members of the secondary storage site.

For secondary side read Op handling, to prevent the read of a potentially stale region on a member of the secondary storage site, the primary storage site responds to inflight operations only after ensuring that the secondary storage site has also gone OOS and is not allowing I/O operations. A design based on a timeout is used here. For example, the primary storage site ensures that a short time period (e.g., at least 5 seconds, at least 10 seconds) has elapsed from the time the relationship went OOS before responding to any in-flight op with success. By expiration of this short time period, the primary storage site would have detected OOS and activated its fence mechanism to prevent further I/O operations. This design helps deal with scenarios like network partition where primary storage site and secondary storage site will not be able to communicate with each other.

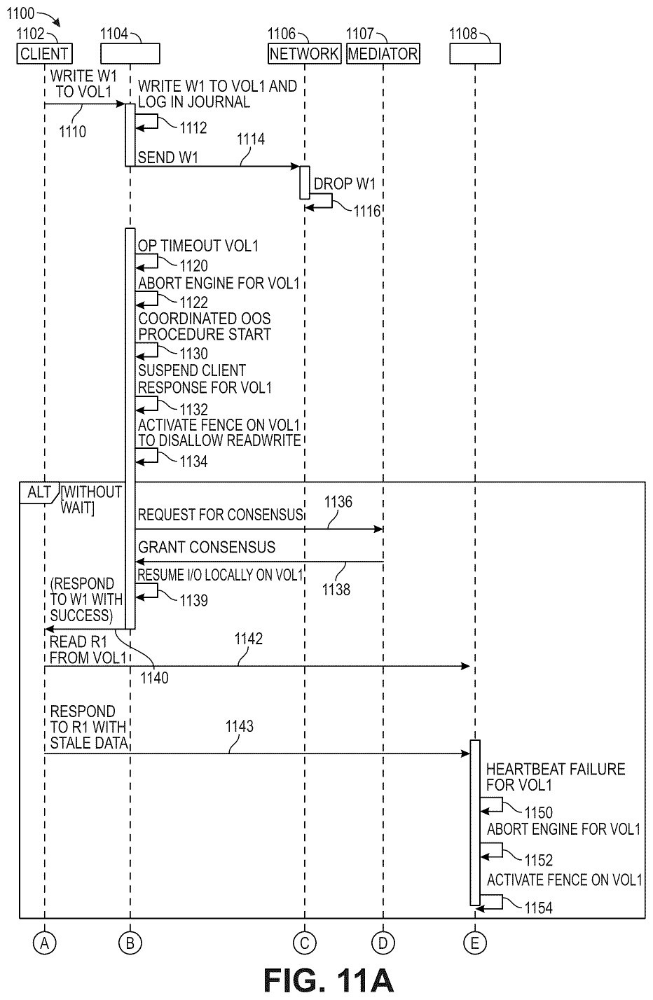

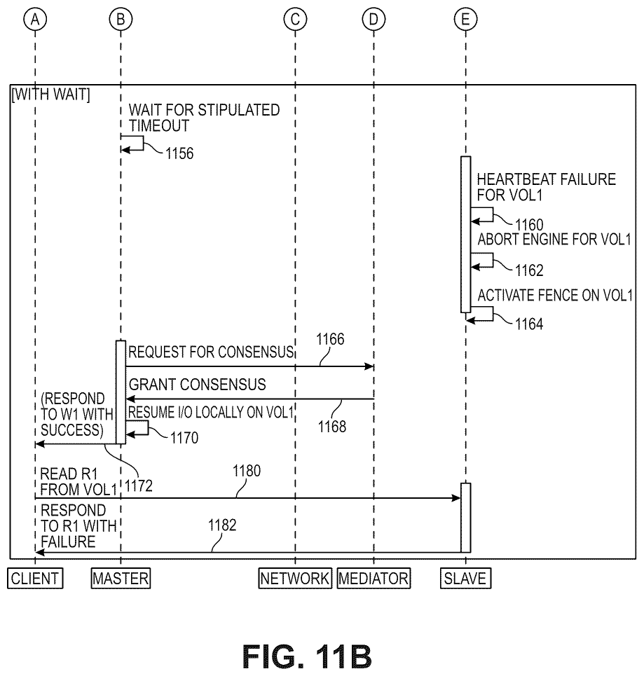

FIGS. 11A-11B illustrate a flow diagram for an order of operations of a computer-implemented method for performing secondary side read Op handling to maintain dependent write order consistency for a symmetric distributed storage system in accordance with an embodiment of the present disclosure. State information regarding members (e.g., storage volumes) of a local CG can be maintained. The state information may include a data replication status of a mirror copy of a dataset associated with a local CG (e.g., CG 515a) may be maintained, for example, to facilitate automatic triggering of resynchronization. For example, the state information may include information relating to the current availability or unavailability of a peer volume of a remote CG corresponding to a member volume of the local CG and/or the data replication state of the local CG. In one embodiment, the state information may track the current state of a given CG and a given volume consistent with the state diagrams of FIG. 6A and FIG. 6B.

Although the operations in the computer-implemented method 1100 are shown in a particular order, the order of the actions can be modified. Thus, the illustrated embodiments can be performed in a different order, and some operations may be performed in parallel. Some of the operations listed in FIGS. 11A-11B are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of computer-implemented method 1100 may be executed by a storage controller, a storage virtual machine (e.g., SVM 511a, SVM 511b), a mediator (e.g., mediator 120, mediator 220, mediator 360), a mediator agent (e.g., mediator agent 139a-139n, mediator agent 149a-149n, mediator agent 239a-239n, mediator agent 249a-249n, mediator agent 313, 314, 323, 324, mediator agent 439), a multi-site distributed storage system, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

In one embodiment, a multi-site distributed storage system includes the primary storage site 1104 having a first cluster with a primary copy of data in a consistency group (CG1). The consistency group of the first cluster is initially assigned primary role. A second cluster of the secondary storage site 1108 has a secondary mirror copy of the data in a consistency group. The consistency group of the second cluster (CG2) is initially assigned a secondary role. The storage system handles input/output (I/O) requests from the client device 1102 having an application. The primary storage site 1104 and secondary storage site 1108 communicate via a network 1106. The primary storage site 804 and secondary storage site 808 communicate via a network 806. Initially, the method establishes bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO).

At operation 1110, the method includes receiving a write operation with a first member (e.g., volume) of a primary storage site 1104 from a client device 1102. At operation 1112, the method includes writing W1 to the first member at primary storage site 1104 and logging the write W1 in an op log journal. In this example, a network connection for the network 1106 is failing and the network is not able to send write W1 to the secondary storage site 1108 at operation 1114. At operation 1116, the method includes dropping the write operation W1 at the network 1106. At operation 1120, an Op timeout expires due to an acknowledgement not being received at the first member for the write W1. This causes a replication engine for the first member to abort at operation 1122.

At operation 1130, a coordinated OOS procedure starts due to the first member of the primary storage site being out of sync (OOS) with the first member of the secondary storage site. At operation 1132, the method includes suspending a response to a client device for the first member. At operation 1134, the method includes disallowing read/write access on the primary storage site by activating a fence on the first member.

Operations 1136 through 1154 represent an alternative approach without waiting for a stipulated timeout and this causes a read of stale data from the secondary storage site. At operation 1136, the method includes sending a request for Consensus from the primary storage site to the mediator 1107. At operation 1138, the method includes granting the primary storage site with the Consensus. At operation 1139, the method includes resuming I/O operations locally on the first member of the primary storage site.

At operation 1140, the method includes responding to W1 with a success message being sent to the client device. At operation 1142, the method includes sending a read Op (R1) from the client device to a first member of the secondary storage site 1108. During normal operation, the first member of the secondary storage site will be in synchronous replication with the first member of the primary storage site. At operation 1144, the method includes responding to the read Op (R1) to the client device with stale data from the first member of the secondary storage site 1108.

The secondary storage site 1108 periodically receives heartbeat messages from the primary storage site 1104 during normal conditions with no failures. However, at operation 1150, a time period for receiving a heartbeat message from the primary storage site expires and this causes a heartbeat failure. A replication engine for the first member aborts at operation 1152 and activation of a fence on the first member (e.g., volume, data container) of the secondary storage site occurs at operation 1154 to disallow read/write operations in response to the heartbeat failure.

In one embodiment, Operations 1156 through 1182 represent a workflow that includes waiting for a stipulated timeout and this avoids causing a read of stale data from the secondary storage site. At operation 1156, the method includes waiting for a stipulated timeout at the primary storage site. At operation 1160, a time period for receiving a heartbeat message from the primary storage site expires and this causes a heartbeat failure. A replication engine for the first member aborts at operation 1162 and activation of a fence on the first member (e.g., volume, data container) of the secondary storage site occurs at operation 1164 to disallow read/write operations in response to the heartbeat failure.

At operation 1166, the method includes sending a request for Consensus from the primary storage site to the mediator 1107. At operation 1168, the method includes granting the primary storage site with the Consensus. At operation 1170, the method includes resuming I/O operations locally on the first member of the primary storage site.

At operation 1172, the method includes responding to W1 with a success message being sent to the client device. At operation 1180, the method includes sending a read Op (R1) from the client device to a first member of the secondary storage site 1108. During normal operation, the first member of the secondary storage site will be in synchronous replication with the first member of the primary storage site. At operation 1182, the method includes responding to the read Op (R1) to the client device with a failure message due to the OOS state between the primary and secondary storage sites and the disallowing of read/write operations on the secondary storage site.

This design preserves the last known good state of the mirror by creating a CG snapshot before starting a snapshot-based resync. This snapshot can be used in case of a primary site failure before resync completes. For example: If a primary site fails before resync completes, the system can revert to the last known good state captured in the snapshot, ensuring dependent write order consistency.

### Example Computer System

Embodiments of the present disclosure include various steps, which have been described above. The steps may be performed by hardware components or may be embodied in machine-executable instructions, which may be used to cause a processing resource (e.g., a general-purpose or special-purpose processor) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium (or non-transitory computer-readable medium) may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

FIG. 12 is a block diagram that illustrates a computer system 1500 in which or with which an embodiment of the present disclosure may be implemented. Computer system 1500 may be representative of all or a portion of the computing resources associated with a storage node (e.g., storage node 136a-n, storage node 146a-n, storage node 156a-b, storage node 236a-n, storage node 246a-n, nodes 311-312, nodes 321-322, nodes 356a-356b, storage node 400), a mediator (e.g., mediator 120, mediator 220, mediator 360), or an administrative workstation (e.g., computer system 110, computer system 210). Notably, components of computer system 1500 described herein are meant only to exemplify various possibilities. In no way should example computer system 1500 limit the scope of the present disclosure. In the context of the present example, computer system 1500 includes a bus 1502 or other communication mechanism for communicating information, and a processing resource (e.g., processing logic, hardware processor(s) 1504) coupled with bus 1502 for processing information. Hardware processor 504 may be, for example, a general purpose microprocessor.

Computer system 1500 also includes a main memory 1506, such as a random access memory (RAM) or other dynamic storage device, coupled to bus 1502 for storing information and instructions to be executed by processor 1504. Main memory 1506 also may be used for storing temporary variables or other intermediate information during execution of instructions to be executed by processor 1504. Such instructions, when stored in non-transitory storage media accessible to processor 1504, render computer system 1500 into a special-purpose machine that is customized to perform the operations specified in the instructions.

Computer system 1500 further includes a read only memory (ROM) 1508 or other static storage device coupled to bus 1502 for storing static information and instructions for processor 1504. A storage device 1510, e.g., a magnetic disk, optical disk or flash disk (made of flash memory chips), is provided and coupled to bus 1502 for storing information and instructions.

Computer system 1500 may be coupled via bus 1502 to a display 1512, e.g., a cathode ray tube (CRT), Liquid Crystal Display (LCD), Organic Light-Emitting Diode Display (OLED), Digital Light Processing Display (DLP) or the like, for displaying information to a computer user. An input device 1514, including alphanumeric and other keys, is coupled to bus 1502 for communicating information and command selections to processor 1504. Another type of user input device is cursor control 1516, such as a mouse, a trackball, a trackpad, or cursor direction keys for communicating direction information and command selections to processor 1504 and for controlling cursor movement on display 1512. This input device typically has two degrees of freedom in two axes, a first axis (e.g., x) and a second axis (e.g., y), that allows the device to specify positions in a plane.

Removable storage media 1540 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 1500 may implement the techniques described herein using customized hard-wired logic, one or more ASICs or FPGAs, firmware or program logic which in combination with the computer system causes or programs computer system 1500 to be a special-purpose machine. According to one embodiment, the techniques herein are performed by computer system 1500 in response to processor 1504 executing one or more sequences of one or more instructions contained in main memory 1506. Such instructions may be read into main memory 1506 from another storage medium, such as storage device 1510. Execution of the sequences of instructions contained in main memory 1506 causes processor 1504 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 1510. Volatile media includes dynamic memory, such as main memory 1506. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, a non-transitory computer-readable storage medium, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1502. Transmission media can also take the form of acoustic or light waves, such as those generated during radio-wave and infra-red data communications.

Various forms of media may be involved in carrying one or more sequences of one or more instructions to processor 1504 for execution. For example, the instructions may initially be carried on a magnetic disk or solid state drive of a remote computer. The remote computer can load the instructions into its dynamic memory and send the instructions over a telephone line using a modem. A modem local to computer system 1500 can receive the data on the telephone line and use an infra-red transmitter to convert the data to an infra-red signal. An infra-red detector can receive the data carried in the infra-red signal and appropriate circuitry can place the data on bus 1502. Bus 1502 carries the data to main memory 1506, from which processor 1504 retrieves and executes the instructions. The instructions received by main memory 1506 may optionally be stored on storage device 1510 either before or after execution by processor 1504.

Computer system 1500 also includes a communication interface 1518 coupled to bus 1502. Communication interface 1518 provides a two-way data communication coupling to a network link 1520 that is connected to a local network 1522. For example, communication interface 1518 may be an integrated services digital network (ISDN) card, cable modem, satellite modem, or a modem to provide a data communication connection to a corresponding type of telephone line. As another example, communication interface 1518 may be a local area network (LAN) card to provide a data communication connection to a compatible LAN. Wireless links may also be implemented. In any such implementation, communication interface 1518 sends and receives electrical, electromagnetic or optical signals that carry digital data streams representing various types of information.

Network link 1520 typically provides data communication through one or more networks to other data devices. For example, network link 1520 may provide a connection through local network 1522 to a host computer 1524 or to data equipment operated by an Internet Service Provider (ISP) 1526. ISP 1526 in turn provides data communication services through the world wide packet data communication network now commonly referred to as the “Internet” 1528. Local network 1522 and Internet 1528 both use electrical, electromagnetic or optical signals that carry digital data streams. The signals through the various networks and the signals on network link 1520 and through communication interface 1518, which carry the digital data to and from computer system 1500, are example forms of transmission media.

Computer system 1500 can send messages and receive data, including program code, through the network(s), network link 1520 and communication interface 1518. In the Internet example, a server 1530 might transmit a requested code for an application program through Internet 1528, ISP 1526, local network 1522 and communication interface 1518. The received code may be executed by processor 1504 as it is received, or stored in storage device 1510, or other non-volatile storage for later execution.

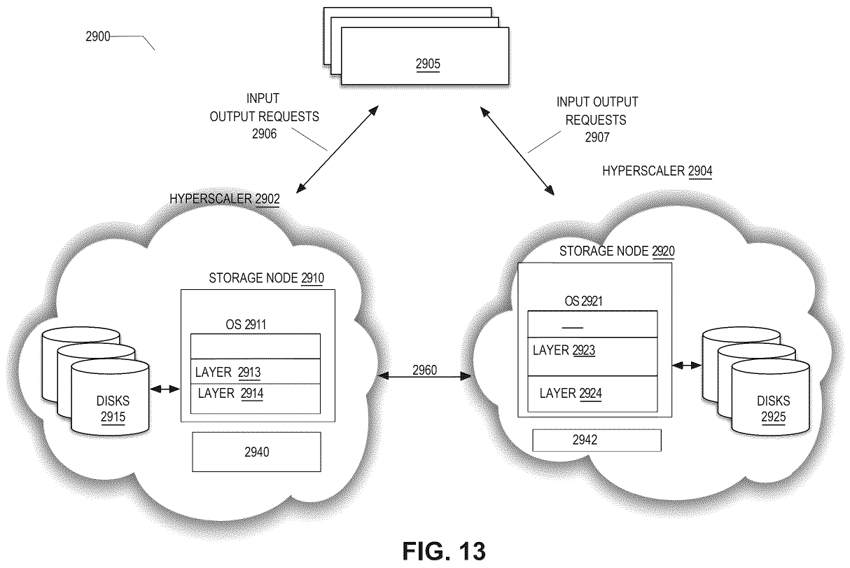

FIG. 13 is a block diagram illustrating a cloud environment in which various embodiments may be implemented (e.g., virtual storage nodes of a primary storage site, a secondary storage site, and a tertiary storage site). In various examples described herein, a virtual storage system 2900 may be run (e.g., on a VM or as a containerized instance, as the case may be) within a public cloud provider (e.g., hyperscaler 2902, 2904). In the context of the present example, the virtual storage system 2900 includes virtual storage nodes 2910 and 2920 and makes use of cloud disks (e.g., hyperscale disks 2915, 2925) provided by the hyperscaler.

The virtual storage system 2900 may present storage over a network to clients 2905 using various protocols (e.g., object storage protocol (OSP), small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. Clients 2905 may request services of the virtual storage system 2900 by issuing Input/Output requests 2906, 2907 (e.g., file system protocol messages (in the form of packets) over the network). A representative client of clients 2905 may comprise an application, such as a database application, executing on a computer that “connects” to the virtual storage system over a computer network, such as a point-to-point channel, a shared local area network (LAN), a wide area network (WAN), or a virtual private network (VPN) implemented over a public network, such as the Internet.

In the context of the present example, the virtual storage system 2900 includes virtual storage nodes 2910 and 2920 with each virtual storage node being shown includes an operating system. The virtual storage node 2910 includes an operating system 2911 having layers 2913 and 2914 of a protocol stack for processing of object storage protocol operations or requests.

The virtual storage node 2920 includes an operating system 2921, layers 2923 and 2924 of a protocol stack for processing of object storage protocol operations or requests.

The storage nodes can include storage device drivers for transmission of messages and data via the one or more links 2960. The storage device drivers interact with the various types of hyperscale disks 2915, 2925 supported by the hyperscalers.

The data served by the virtual storage nodes may be distributed across multiple storage units embodied as persistent storage devices (e.g., non-volatile memory 2940, 2942), including but not limited to HDDs, SSDs, flash memory systems, or other storage devices (e.g., 2915, 2925).

In some embodiments, methods are disclosed to maintain read-write consistency and dependent write order consistency on the dual copy multi-site distributed data storage systems with simultaneous read-write ability on each copy of the data. According to some embodiments for Example 1, a computer-implemented method to maintain read write consistency between a primary copy of data of a primary storage site and a secondary copy of data of a secondary storage site of a distributed storage system comprises establishing bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO), receiving, with the primary storage site, a first write operation (Op) from a client device, writing the first write Op to a primary copy of data at the primary storage site and logging the first write Op in an op log journal, terminating the first write Op due to a network failure, which causes a replication relationship to be out of sync, when attempting to replicate the first write Op to the secondary storage site, determining a heartbeat failure when a time period for receiving a heartbeat message from the primary storage site expires, aborting a replication engine and activating a fence on the storage node of the secondary storage site to disallow read/write access in response to the heartbeat failure, and generating and sending a reconciliation request from the secondary storage site to the primary storage site upon network recovery for a resynchronization of the replication relationship between the one or more members of the first storage node and one or more members of the second storage node.

Example 2 includes the subject matter of Example 1, the computer-implemented method further comprises in response to the reconciliation request, initiating a reconciliation process between the Op log journal of the primary storage site and an Op log journal of the secondary storage site to ensure the primary storage site and secondary storage site have the same operations and data to maintain read write consistency between a primary copy of data of a primary storage site and a secondary copy of data of a secondary storage site.

Example 3 includes the subject matter of any of Examples 1-2, the computer-implemented method further comprises in response to completion of the reconciliation process, deactivating a fence to allow read/write operations on the primary storage site; and
deactivating a fence to allow read/write operations on the secondary storage site.

Example 4 includes the subject matter of any of Examples 1-3, the computer-implemented method further comprises in response to the reconciliation process for a resynchronization of the replication relationship between the one or more members of the first storage node and one or more members of the second storage node, retrying the first write Op at the primary storage site; writing the first write op to the primary copy of data and logging the first write op in a journal on the primary storage site; replicating the first write Op to the secondary storage site to complete the reconciliation; writing the first write Op and logging the first write Op in a journal on the secondary storage site; sending a replication acknowledgement from the secondary storage site to the primary storage site; responding to the client device with a successful writing of the first write Op after successfully writing the first write Op to the primary and secondary storage sites regardless of whether the primary storage site or the secondary storage site initially receives the first write Op to maintain consistency across the first and secondary storage site; receiving a dependent second write Op at the primary storage site that is dependent upon the first write Op; replicating the dependent second write Op to the secondary storage site; writing the dependent second write op and logging in a journal on the secondary storage site; sending a replication acknowledgement from the secondary storage site to the primary storage site; and responding to the client with a successful writing of the second write op.

Example 5 includes the subject matter of any of Examples 1-4, the computer-implemented method further comprises responding to the write Op with a failure status to indicate that the write Op was not successfully replicated to the secondary storage site.

Example 6 includes the subject matter of any of Examples 1-5, wherein establishing bi-directional synchronous replication between one or more members of a storage node of the primary storage site and one or more members of a storage node of the secondary storage site comprises initiating a data replication relationship between the one or more members of the first storage node and the one or more members of the second storage node while maintaining zero RPO and Zero RTO.

Example 7 includes the subject matter of any of Examples 1-6, the computer-implemented method further comprises aborting a replication engine at the primary storage site; and activating a fence to disallow read/write access to the first storage node of the primary storage site due to an Op timeout when no acknowledgement is received for the write Op during a timeout period of the Op timeout.

Some embodiments relate to Example 8 that includes a non-transitory computer-readable storage medium embodying a set of instructions, which when executed by one or more processing resources of a distributed storage system having a primary storage site and a secondary storage site, cause the distributed storage system to establish bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO); receive, with the primary storage site, a write operation (Op) from a client device; write the write Op to a primary copy of data at the primary storage site and logging the write Op in an op log journal; terminate the write Op due to a network failure of a network, which causes a replication relationship to be out of sync, when attempting to replicate the write Op to the secondary storage site; determine a heartbeat failure when a time period for receiving a heartbeat message from the primary storage site expires; abort a replication engine and activating a fence on the storage node of the secondary storage site to disallow read/write access in response to the heartbeat failure; and upon network restoration, generate and send a consensus request from the primary storage site to a mediator at a third site to determine a primary role for serving input/output (I/O) operations for the primary storage site or the secondary storage site to avoid a split-brain scenario when the primary and secondary storage sites are temporarily unable to communicate with each other.

Example 9 includes the subject matter of Example 8, wherein the instructions further cause the distributed storage system to vote, with the mediator and primary storage site, to grant consensus to assign the primary role for serving I/O operations to the primary storage site.

Example 10 includes the subject matter of any of Examples 8-9, wherein the instructions further cause the distributed storage system to allow read/write operations on the primary storage site.

Example 11 includes the subject matter of any of Examples 8-10, wherein the instructions further cause the distributed storage system to generate and send, with the secondary storage site, a resynchronization request to the primary storage site.

Example 12 includes the subject matter of any of Examples 8-11, wherein the instructions further cause the distributed storage system to perform resynchronization between the primary storage site and secondary storage site using one or more snapshots of the one or more members of the first storage node of the primary storage site.

Example 13 includes the subject matter of any of Examples 8-12, wherein the instructions further cause the distributed storage system to upon completing resynchronization, allowing read/write operations on the secondary storage site.

Example 14 includes the subject matter of any of Examples 8-13, wherein establishing bi-directional synchronous replication between one or more members of a storage node of the primary storage site and one or more members of a storage node of the secondary storage site comprises initiating a data replication relationship between the one or more members of the first storage node and the one or more members of the second storage node while maintaining zero RPO and Zero RTO.

Some embodiments for Example 15 include a distributed storage system comprising one or more processing resource; and one or more non-transitory computer-readable media, coupled to the one or more processing resources, having stored therein instructions that when executed by the one or more processing resource cause the distributed storage system to establish bi-directional synchronous replication between one or more members of a first storage node of a primary storage site and one or more members of a second storage node of a secondary storage site with each storage node having read/write access while maintaining zero recovery point objective (RPO) and Zero recovery time objective (RTO) and with a primary storage site first replication principle; receive, with a first member of the first storage node of primary storage site, a first write operation (Op) from a client device; write the first write Op to a primary copy of data at the primary storage site and log the first write Op in an op log journal based on primary side first principle; terminate the first write Op due to a network failure of a network, which causes a synchronous replication relationship to be in out of sync (OOS) state, when attempting to replicate the first write Op to the secondary storage site; start a coordinated out of sync (OOS) procedure due to the first member of the primary storage site being out of sync (OOS) with the first member of the secondary storage site; receive, with a second member of the first storage node of the primary storage site, a second write Op that is dependent on the first write Op; write the second write Op to the primary copy of data at the primary storage site and log the second write Op in an op log journal; and preserve write order consistency by not replicating the second write Op to the secondary storage site based on the OOS state.

Example 16 includes the subject matter of Example 15, wherein the instructions further cause the distributed storage system to determine expiration of an Op timeout due to an acknowledgement not being received at the primary storage site for the first write op; determine a heartbeat failure due to a time period for receiving a heartbeat message from the primary storage site expiring; abort a replication engine and activate a fence for the secondary storage site to disallow read/write access based on the heartbeat failure; fail to send a reconciliation request from the secondary storage site to the primary storage site for resynchronization of the synchronous replication relationship due to the network not recovering from failure; determine a timeout at the primary storage site while waiting for the reconciliation request from the secondary storage site; abort a replication engine for the first member of the primary storage site based on the OOS state; abort a replication engine for a second member of the primary storage site based on the coordinated OOS procedure; suspend a response to the client device for the first member of the first storage node; suspend a response to the client device for the second member of the first storage node; disallow read/write access to the first member on the primary storage site by activating a fence on the first member; disallow read/write access to the second member of the primary storage site by activating a fence on the second member; respond to the first write Op with a failure status at the first member of the primary storage site to indicate that the first write Op was not successfully replicated to the secondary storage site; determine a heartbeat failure at any remaining members of the secondary storage site when the time period for receiving a heartbeat message from the primary storage site expires; abort a replication engine and activate a fence at any remaining members of the secondary site to disallow read/write access; and wait for a stipulated timeout at all members of the primary storage site to ensure that their counterpart members at the secondary storage site have detected the out-of-sync state and activated their fence mechanisms before responding to any in-flight operations.

Example 17 includes the subject matter of any of Examples 15-16, wherein the instructions further cause the distributed storage system to generate and send a consensus request from the primary storage site to a mediator of a third site to determine a primary role for serving input/output (I/O) operations for the primary storage site or the secondary storage site to avoid a split-brain scenario when the primary and secondary storage sites are temporarily unable to communicate with each other; vote, with the mediator and the primary storage site, to grant consensus to assign the primary role for serving I/O operations to the primary storage site; allow read/write operations on the primary storage site by using the consensus to remove the fence; retry the first write Op received by the first member of the primary storage site and write the first write Op to a primary copy of data at the primary storage site, responding to the client with success after successfully writing the first write Op to the primary and secondary storage sites regardless of whether the primary storage site or the secondary storage site initially receives the first write Op to maintain consistency across the first and secondary storage sites; receive the second write Op at the second member of the primary storage site that is dependent on the first write Op and write the second write Op to a primary copy of data at the primary storage site, responding to the client with success without replicating the second write op to the secondary copy as the replication engine is aborted, thereby maintaining dependent write order consistency on the secondary copy of data in the absence of first write op.

Example 18 includes the subject matter of any of Examples 15-17, wherein the instructions further cause the distributed storage system to receive, with any member of the second storage node of the secondary storage site, a third write Op that is dependent on the first write Op and reject the third write Op with failure upon failure to replicate the third write Op to the primary storage site as per the primary-first replication principle; preserve write order consistency by not executing the third write Op on the secondary storage node and not replicating the third write Op to the primary storage site based on the OOS state; receive a read Op at any member of the secondary storage site to read the data written by the first, second, or third write Op, and reject the read Op with failure due to the fence, thereby maintaining read consistency in the absence of first, second and third write ops; generate and send a resynchronization request from the secondary storage site to the primary storage site when the network recovers from failure; perform resynchronization between the primary storage site and the secondary storage site using one or more snapshots of the members of the first storage node of the primary storage site; upon completing resynchronization, initiate a bi-directional synchronous data replication relationship between the members of the first storage node and the members of the second storage node while maintaining zero RPO and zero RTO; allow read/write operations on the secondary storage site by deactivating the fence when the primary and secondary copies are in sync.

Example 19 includes the subject matter of any of Examples 15-18, wherein the instructions further cause the distributed storage system to activate a fence on the first member of the first storage node to disallow read/write access to the first member of the first storage node; wait for a stipulated timeout; in response to determining a heartbeat failure for the first member of the first storage node, abort a replication engine for the first member of the secondary storage site; and activate a fence on the first member of the second storage node to disallow read/write access to the second member of the second storage node.

Example 20 includes the subject matter of any of Examples 15-19, wherein the instructions further cause the distributed storage system to send a request for Consensus from the primary storage site to a mediator of a third site; grant the primary storage site with the Consensus; resume I/O operations locally on the first member of the primary storage site; respond to the first write Op with a success message being sent to the client device; send a read Op from the client device to a first member of the secondary storage site to read the data written by the first write op; and respond to the read Op to the client device with a failure due to the OOS state between the primary storage site and the secondary storage site.

What is claimed is:

1. A computer-implemented method to maintain read write consistency between a primary copy of data of a primary storage site and a secondary copy of data of a secondary storage site of a distributed storage system, the method comprising:
establishing bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO);
receiving, with the primary storage site, a first write operation (Op) from a client device;
writing the first write Op to a primary copy of data at the primary storage site and logging the first write Op in an op log journal;
terminating the first write Op due to a network failure, which causes a replication relationship to be out of sync, when attempting to replicate the first write Op to the secondary storage site;
determining a heartbeat failure when a time period for receiving a heartbeat message from the primary storage site expires;
aborting a replication engine and activating a fence on the storage node of the secondary storage site to disallow read/write access in response to the heartbeat failure; and
generating and sending a reconciliation request from the secondary storage site to the primary storage site upon network recovery for a resynchronization of the replication relationship between the one or more members of the first storage node and one or more members of the second storage node.

2. The computer-implemented method of claim 1, further comprising:
in response to the reconciliation request, initiating a reconciliation process between the Op log journal of the primary storage site and an Op log journal of the secondary storage site to ensure the primary storage site and secondary storage site have the same operations and data to maintain read write consistency between a primary copy of data of a primary storage site and a secondary copy of data of a secondary storage site.

3. The computer-implemented method of claim 2, further comprising:
in response to completion of the reconciliation process, deactivating a fence to allow read/write operations on the primary storage site; and
deactivating a fence to allow read/write operations on the secondary storage site.

4. The computer-implemented method of claim 2, further comprising:
in response to the reconciliation process for a resynchronization of the replication relationship between the one or more members of the first storage node and one or more members of the second storage node, retrying the first write Op at the primary storage site;
writing the first write op to the primary copy of data and logging the first write op in a journal on the primary storage site;
replicating the first write Op to the secondary storage site to complete the reconciliation;
writing the first write Op and logging the first write Op in a journal on the secondary storage site;
sending a replication acknowledgement from the secondary storage site to the primary storage site;
responding to the client device with a successful writing of the first write Op after successfully writing the first write Op to the primary and secondary storage sites regardless of whether the primary storage site or the secondary storage site initially receives the first write Op to maintain consistency across the first and secondary storage site;
receiving a dependent second write Op at the primary storage site that is dependent upon the first write Op;
replicating the dependent second write Op to the secondary storage site;
writing the dependent second write op and logging in a journal on the secondary storage site;
sending a replication acknowledgement from the secondary storage site to the primary storage site; and
responding to the client with a successful writing of the second write op.

5. The computer-implemented method of claim 1, further comprising:
responding to the write Op with a failure status to indicate that the write Op was not successfully replicated to the secondary storage site.

6. The computer-implemented method of claim 1, wherein establishing bi-directional synchronous replication between one or more members of a storage node of the primary storage site and one or more members of a storage node of the secondary storage site comprises:
initiating a data replication relationship between the one or more members of the first storage node and the one or more members of the second storage node while maintaining zero RPO and Zero RTO.

7. The computer-implemented method of claim 1, further comprising:
aborting a replication engine at the primary storage site; and
activating a fence to disallow read/write access to the first storage node of the primary storage site due to an Op timeout when no acknowledgement is received for the write Op during a timeout period of the Op timeout.

8. A non-transitory computer-readable storage medium embodying a set of instructions, which when executed by one or more processing resources of a distributed storage system having a primary storage site and a secondary storage site, cause the one or more processing resources to:
establish bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO);
receive, with the primary storage site, a write operation (Op) from a client device;
write the write Op to a primary copy of data at the primary storage site and logging the write Op in an op log journal;
terminate the write Op due to a network failure of a network, which causes a replication relationship to be out of sync, when attempting to replicate the write Op to the secondary storage site;
determine a heartbeat failure when a time period for receiving a heartbeat message from the primary storage site expires;
abort a replication engine and activating a fence on the storage node of the secondary storage site to disallow read/write access in response to the heartbeat failure; and
upon network restoration, generate and send a consensus request from the primary storage site to a mediator at a third site to determine a primary role for serving input/output (I/O) operations for the primary storage site or the secondary storage site to avoid a split-brain scenario when the primary and secondary storage sites are temporarily unable to communicate with each other.

9. The non-transitory computer-readable storage medium of claim 8, wherein the instructions further cause the one or more processing resources to:
vote, with the mediator and primary storage site, to grant consensus to assign the primary role for serving I/O operations to the primary storage site.

10. The non-transitory computer-readable storage medium of claim 8, wherein the instructions further cause the one or more processing resources to:
allow read/write operations on the primary storage site.

11. The non-transitory computer-readable storage medium of claim 8, wherein the instructions further cause the one or more processing resources to:
generating and send, with the secondary storage site, a resynchronization request to the primary storage site.

12. The non-transitory computer-readable storage medium of claim 8, wherein the instructions further cause the one or more processing resources to:
perform resynchronization between the primary storage site and secondary storage site using one or more snapshots of the one or more members of the first storage node of the primary storage site.

13. The non-transitory computer-readable storage medium of claim 12, wherein the instructions further cause the one or more processing resources to:
upon completing resynchronization, allowing read/write operations on the secondary storage site.

14. The non-transitory computer-readable storage medium of claim 8, wherein establishing bi-directional synchronous replication between one or more members of a storage node of the primary storage site and one or more members of a storage node of the secondary storage site comprises:
initiating a data replication relationship between the one or more members of the first storage node and the one or more members of the second storage node while maintaining zero RPO and Zero RTO.

15. A distributed storage system comprising:
one or more processing resource; and
one or more non-transitory computer-readable media, coupled to the one or more processing resources, having stored therein instructions that when executed by the one or more processing resource cause the one or more processing resources to:
establish bi-directional synchronous replication between one or more members of a first storage node of a primary storage site and one or more members of a second storage node of a secondary storage site with each storage node having read/write access while maintaining zero recovery point objective (RPO) and Zero recovery time objective (RTO) and with a primary storage site first replication principle;
receive, with a first member of the first storage node of primary storage site, a first write operation (Op) from a client device;
write the first write Op to a primary copy of data at the primary storage site and log the first write Op in an op log journal based on primary side first principle;
terminate the first write Op due to a network failure of a network, which causes a synchronous replication relationship to be in out of sync (OOS) state, when attempting to replicate the first write Op to the secondary storage site;
start a coordinated out of sync (OOS) procedure due to the first member of the primary storage site being out of sync (OOS) with the first member of the secondary storage site;
receive, with a second member of the first storage node of the primary storage site, a second write Op that is dependent on the first write Op;
write the second write Op to the primary copy of data at the primary storage site and log the second write Op in an op log journal; and
preserve write order consistency by not replicating the second write Op to the secondary storage site based on the OOS state.

16. The distributed storage system of claim 15, wherein the instructions further cause the one or more processing resources to:
determine expiration of an Op timeout due to an acknowledgement not being received at the primary storage site for the first write op;
determine a heartbeat failure due to a time period for receiving a heartbeat message from the primary storage site expiring;
abort a replication engine and activate a fence for the secondary storage site to disallow read/write access based on the heartbeat failure;
fail to send a reconciliation request from the secondary storage site to the primary storage site for resynchronization of the synchronous replication relationship due to the network not recovering from failure;
determine a timeout at the primary storage site while waiting for the reconciliation request from the secondary storage site;
abort a replication engine for the first member of the primary storage site based on the OOS state;
abort a replication engine for a second member of the primary storage site based on the coordinated OOS procedure;
suspend a response to the client device for the first member of the first storage node;
suspend a response to the client device for the second member of the first storage node;
disallow read/write access to the first member on the primary storage site by activating a fence on the first member;
disallow read/write access to the second member of the primary storage site by activating a fence on the second member;
respond to the first write Op with a failure status at the first member of the primary storage site to indicate that the first write Op was not successfully replicated to the secondary storage site;
determine a heartbeat failure at any remaining members of the secondary storage site when the time period for receiving a heartbeat message from the primary storage site expires;
abort a replication engine and activate a fence at any remaining members of the secondary site to disallow read/write access; and
wait for a stipulated timeout at all members of the primary storage site to ensure that their counterpart members at the secondary storage site have detected the out-of-sync state and activated their fence mechanisms before responding to any in-flight operations.

17. The distributed storage system of claim 16, wherein the instructions further cause the one or more processing resources to:
generate and send a consensus request from the primary storage site to a mediator of a third site to determine a primary role for serving input/output (I/O) operations for the primary storage site or the secondary storage site to avoid a split-brain scenario when the primary and secondary storage sites are temporarily unable to communicate with each other;
vote, with the mediator and the primary storage site, to grant consensus to assign the primary role for serving I/O operations to the primary storage site;
allow read/write operations on the primary storage site by using the consensus to remove the fence;
retry the first write Op received by the first member of the primary storage site and write the first write Op to a primary copy of data at the primary storage site, responding to the client with success after successfully writing the first write Op to the primary and secondary storage sites regardless of whether the primary storage site or the secondary storage site initially receives the first write Op to maintain consistency across the first and secondary storage sites;
receive the second write Op at the second member of the primary storage site that is dependent on the first write Op and write the second write Op to a primary copy of data at the primary storage site, responding to the client with success without replicating the second write op to the secondary copy as the replication engine is aborted, thereby maintaining dependent write order consistency on the secondary copy of data in the absence of first write op.

18. The distributed storage system of claim 17, wherein the instructions further cause the one or more processing resources to:
receive, with any member of the second storage node of the secondary storage site, a third write Op that is dependent on the first write Op and reject the third write Op with failure upon failure to replicate the third write Op to the primary storage site as per the primary-first replication principle;
preserve write order consistency by not executing the third write Op on the secondary storage node and not replicating the third write Op to the primary storage site based on the OOS state;
receive a read Op at any member of the secondary storage site to read the data written by the first, second, or third write Op, and reject the read Op with failure due to the fence, thereby maintaining read consistency in the absence of first, second and third write ops;
generate and send a resynchronization request from the secondary storage site to the primary storage site when the network recovers from failure;
perform resynchronization between the primary storage site and the secondary storage site using one or more snapshots of the members of the first storage node of the primary storage site;
upon completing resynchronization, initiate a bi-directional synchronous data replication relationship between the members of the first storage node and the members of the second storage node while maintaining zero RPO and zero RTO;
allow read/write operations on the secondary storage site by deactivating the fence when the primary and secondary copies are in sync.

19. The distributed storage system of claim 15, wherein the instructions further cause the one or more processing resources to:
activate a fence on the first member of the first storage node to disallow read/write access to the first member of the first storage node;
wait for a stipulated timeout;
in response to determining a heartbeat failure for the first member of the first storage node, abort a replication engine for the first member of the secondary storage site; and
activate a fence on the first member of the second storage node to disallow read/write access to the second member of the second storage node.

20. The distributed storage system of claim 19, wherein the instructions further cause the one or more processing resources to:
send a request for Consensus from the primary storage site to a mediator of a third site;
grant the primary storage site with the Consensus;
resume I/O operations locally on the first member of the primary storage site;
respond to the first write Op with a success message being sent to the client device;
send a read Op from the client device to a first member of the secondary storage site to read the data written by the first write op; and
respond to the read Op to the client device with a failure due to the OOS state between the primary storage site and the secondary storage site.
